(19) United States
(12) Patent Application Publication
(10) Pub. No.: US 2007/0050240 A1
(43) Pub. Date: Mar. 1, 2007

(54) Wireless Parking Guidance System

(75) Inventors: Eshwar Belani, San Jose, CA (US); Santosh Godbole, Bangalore (IN); Mala Rangarajan, Bangalore (IN); Samuel Rajasingh, Chennai (IN); Sushil Siddesh, Bangalore (IN); Harish Prabhu, NIT, Trichy (IN); Neha Jain, Sunnyvale, CA (US)

Correspondence Address: AKA CHAN LLP, 900 LAFAYETTE STREET, SUITE 710, SANTA CLARA, CA, 95050, US

(73) Assignee: SENSACT APPLICATIONS, INC., San Jose, CA (US)

(21) Appl. No.: 11/468,722

(22) Filed: Aug. 30, 2006

Related U.S. Application Data
(60) Provisional application No. 60/596,089, filed on Aug. 30, 2005.

(51) Int. Cl. G07B 15/00

(52) U.S. Cl. 705/13

(57) ABSTRACT

A parking guidance system tracks available parking spaces and leads users to vacant spots through display boards placed at strategic locations in the parking lot. Sensor nodes are deployed at parking spaces or within traffic lanes to monitor parking space occupancy and wirelessly transmit this information. The sensor nodes form a wireless network that routes the knowledge of available spaces to the corresponding display boards and updates them in real time. Parking availability information may also be shared with users in a variety of other ways such as through the Internet, personal digital assistants, computers, mobile telephones, in-vehicle dashboards, and others.

### CROSS-REFERENCE TO RELATED APPLICATION

This patent application claims the benefit of U.S. provisional patent application 60/596,089, filed Aug. 30, 2005. This provisional application and all references cited in this application are incorporated by reference.

### DESCRIPTION

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### BACKGROUND OF THE INVENTION

This invention relates to the field of parking guidance systems and more specifically to a wireless system for parking guidance.

In today's fast-paced and highly competitive environment, it is imperative for parking facility owners to ensure a seamless and enjoyable experience for each visitor. In large cities such as New York, Chicago, San Francisco, Beijing, Shanghai, Tokyo, Seoul, London, Paris, Rome, and Berlin, it is becoming increasingly difficult to find available parking. Even when available parking spaces exist, visitors often have to circle around to find them. This leads to a waste of the visitors' time, increased pollution, increased use of fuel, and increased visitor stress and frustration. In commercial areas, increased time in the parking lot reduces the time consumers are in the stores or mall, which reduces their revenues.

A parking guidance system provides visitors with information on where the available parking spaces are located. However, past approaches to building parking guidance systems have various limitations. The currently available systems are not accurate. Systems that are unable to consistently detect the presence of a vehicle in each parking space do not provide reliable guidance information. The current systems are also prohibitively expensive and cumbersome to install. Systems that use wires or cables to sense the presence of vehicles in parking spaces are very expensive. Additionally, these systems take a long time to install because they require an extensive wired infrastructure and it is very cumbersome to retrofit such systems in existing parking facilities.

Past approaches to detecting vehicles include the use of a variety of sensing methodologies including air hoses, ultrasonic sensors, and inductive loops. A disadvantage to these approaches is that they require extensive wiring to power the sensors and to collect the information that the sensors generate. Hence, parking guidance systems using these past methodologies do not scale to large parking facilities and consequently are not pervasively deployed today.

Therefore, there is a need for an improved parking guidance system.

### BRIEF SUMMARY OF THE INVENTION

A parking guidance system tracks available parking spaces and leads users to vacant spots through display boards placed at strategic locations in the parking lot. Sensor nodes are deployed at parking spaces or within traffic lanes to monitor parking space occupancy and wirelessly transmit this information. The sensor nodes form a wireless network that routes the knowledge of available spaces to the corresponding display boards and updates them in real time. Parking availability information may also be shared with users in a variety of other ways such as through the Internet, personal digital assistants, computers, mobile telephones, in-vehicle dashboards, and others.

The system also includes software tools to remotely monitor utilization of parking spaces in real time. Reports related to utilization of parking lot infrastructure, health, and performance of the wireless network are generated in real time at a server for the convenience of the parking lot maintenance or management staff.

The invention provides a cost effective, accurate, efficient, customer friendly, and scalable parking guidance system. This system will help remove congestion in a parking lot caused by users searching for vacant spots.

In an embodiment, the design and development of sensor node hardware is affordable, energy efficient, and produces accurate readings. The hardware is robust, easy to install, and can be camouflaged within the infrastructure. The invention provides quick and accurate updates to display boards to direct traffic towards vacant spots. The embedded software improves the battery life of sensor node hardware, as well as reliability and response time of the guidance system. User-friendly, front-end tools are available for real-time monitoring, maintenance, and remote management of the parking facilities.

A system of the current invention has numerous advantages. First, the system provides for parking policies enforcement. Second, the system is designed based on a scalable and modular system architecture that can be easily customized to the varying requirements of different types and sizes of parking lot facilities. Third, the system has a self-healing feature that identifies anomalies and malfunctions at run-time and repairs the faults without affecting its on-going operation.

In an embodiment, the system is scalable to meet the needs of networks containing thousands of nodes. The system has extremely robust peer to peer network that is self-healing, It is easy to deploy, self-configurable, and low maintenance. It has a low duty-cycle and intelligent in-network processing, intuitive multiplatform front-end graphical user interface, and bidirectional routing for command and control. Furthermore, the system has a modular architecture to support a variety of application domains and support for commercially available hardware.

In an embodiment, the system may be used with indoor or outdoor parking, or combinations of these two. The technology is resistant to external factors such as weather conditions. The technology is affordable. The system may be wireless so it may be deployed in open infrastructures where it is impossible to install wires or lack power sources. The system provides accurate estimates of the available parking spaces and generates comprehensive report of real-time and historical parking activity.

In an embodiment, the invention is a system including: a first number of sensor nodes distributed in a first parking area to detect the presence of vehicles in parking spaces the first parking area, where the sensors transmits detection information wirelessly; a first bridge node in the first parking area, wirelessly connected to the first number of sensors; a first number of display nodes in the first parking area, wirelessly connected to the first bridge node, where each display node provides an indication of where open parking spaces are located in the first parking area; and a first gateway node, wirelessly connected to the first bridge node and an administrative console to control operation of the system.

Further, the system may include a second number of sensor nodes distributed in a second parking area to detect the presence of vehicles in parking spaces the second parking area, where the sensor transmits detection information wirelessly; a second bridge node in the second parking area, wirelessly connected to the number of sensors; a number of display nodes in the second parking area, wirelessly connected to the second bridge node, where each display node provides an indication of where open parking spaces are located in the second parking area; and a second gateway node, wirelessly connected to the first bridge node and to the administrative console.

In an embodiment, the invention is a method including: using a first sensor node, detecting whether a vehicle is present in a first parking space of a first parking area; from the first sensor node, wirelessly transmitting information on whether the first parking space is occupied to a bridge node; and updating a display to reflect whether the first parking space is occupied or unoccupied based on the information received by the bridge node.

Further, the method may include: using the first sensor node, detecting whether a vehicle is present in a second parking space of the first parking area; from the first sensor node, wirelessly transmitting information on whether the second parking space is occupied to the bridge node; and updating the display to reflect whether the second parking space is occupied or unoccupied based on the information received by the bridge node.

Further, the method may include: using a second sensor node, detecting whether a vehicle is present in a second parking space of first parking area; from the second sensor node, wirelessly transmitting information on whether the second parking space is occupied to the bridge node; and updating the display to reflect whether the second parking space is occupied or unoccupied based on the information received by the bridge node.

In an embodiment, the invention is a system including: a first number of sensor nodes, distributed in a first parking area to detect the presence of vehicles in parking spaces in the first parking area, forming a mesh network where each sensor node transmits detection information wirelessly to at least one other sensor node; a first number of display nodes, in the first parking area, wirelessly connected to the mesh network of sensor nodes, where each display node provides an indication of where open parking spaces are located in the first parking area; and a first gateway node, wirelessly connected to the mesh network of sensor nodes.

Further, the system may include: a second number of sensor nodes distributed in a second parking area to detect the presence of vehicles in parking spaces in the second parking area, forming a mesh network where each sensor transmits detection information wirelessly to at least one other sensor node; a second number of display nodes, in the second parking area, wirelessly connected to the mesh network of sensor nodes, where each display node provides an indication of where open parking spaces are located in the first parking area; and a second gateway node, wirelessly connected to the mesh network of sensor nodes.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 shows the functional components of a parking management system.

FIG. 2 shows the system architecture of a parking management system.

FIG. 3A shows a computer system which may be used in the implementation of a parking management system of the invention.

FIG. 3B shows a system block diagram of the computer system.

FIG. 4A shows a board design of a sensor node or sensor mote.

FIG. 4B shows a sensor node or sensor mote board with batteries and enclosure.

FIG. 5 shows a block diagram depicting the interaction of software modules at the sensor node.

FIG. 6 shows a ferrous object causing a disturbance in a uniform magnetic field.

FIGS. 7A and 7B shows the presence of a vehicle and the direction detection by the sensor in one particular implementation.

FIGS. 7C and 7D shows how a sensor node compensates for drifts in its magnetic readings.

FIGS. 8A, 8B, and 8C show three examples of parking layouts with magnetic sensors to detect space occupancy.

FIG. 9 shows a block diagram of a bridge node.

FIG. 10 shows a hierarchical organization of the network topology.

FIG. 11 shows the interaction among software modules at bridge node.

FIG. 12 shows a timing diagram for media access control (MAC) frames.

FIG. 13 shows a design of a central server.

### DETAILED DESCRIPTION OF THE INVENTION

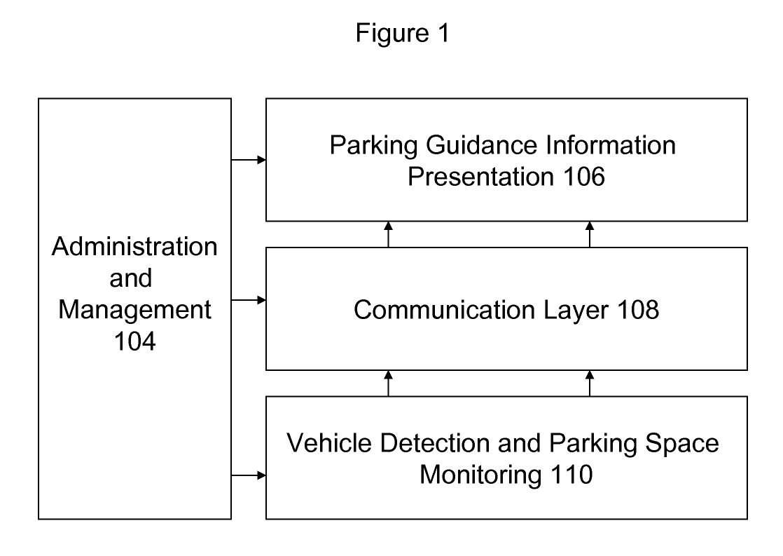

FIG. 1 shows the functional components of a parking management system. The system includes an administration and management component 104, parking guidance information presentation component 106, communication layer component 108, and vehicle detection and parking space monitoring component 110. The administration and management component interfaces with the parking guidance information presentation, communication layer, and vehicle detection and parking space monitoring components. The communication layer component interfaces with the parking guidance information presentation component. The vehicle detection and parking space monitoring component interfaces with the communication layer component.

The vehicle detection and parking space monitoring component helps identify the occupancy status of parking spaces. The communication layer component processes the space availability information and determines the relevant parking guidance information for each direction. The parking guidance information presentation component communicates the guidance information via appropriate visual displays as well as over the Internet. The visual displays may include variable message signs to show the number of available parking spaces in each direction. This information instructs a visitor to drive in the direction most suitable to locate a space in a minimum amount of time. The management and administration component has tools to control and manage the other components.

A system of the invention may have a greater number or a fewer number of functional components than described. The system has four functional components. Other systems may have one, two, or three components, or more than four components, such as five, six, seven, or eight. Two or more functional components may be combined into a single functional component, or a functional component may be divided into multiple functional components, or any combination of these. For example, the vehicle detection and parking space monitoring component may be combined with the communication layer component. Each functional component may include any number of subcomponents. A specific implementation of a parking management system is known as SimplyPark Guidance™, which is made by Sensact Applications, Incorporated.

Functional Overview

The vehicle detection and parking space monitoring component can be designed using a variety of sensor technologies such as ultrasonic sensors, magnetometers, or cameras. There are many types of sensors that may be used to detect a passing vehicle or whether a vehicle is present at a particular location and any of these sensors may be used in a system of the invention. These sensors may also communicate their information wirelessly.

Ultrasonic sensors are typically installed on the ceilings of individual parking spaces in indoor parking lots. These sensors periodically measure the distance from the sensor's location to the ground level using ultrasonic rays and are calibrated with the known distance between the sensor and the ground level. If the ultrasonic sensors discover that the measured distance of the ground from the sensor's location is less than the calibrated distance, they infer a car to be parked at the parking spot and transmit the information wirelessly. In addition to ceilings, ultrasonic sensors may also be mounted on the ground or floor, or on a vertical or side wall.

Cameras can be used to capture images of parking spaces in real time to detect any car coming or leaving the parking space. Different cameras may be positioned to capture different views of the parking spaces and wirelessly transmit their images. Later, images from different cameras may be combined to decide whether a vehicle was observed to be leaving or arriving in a parking space.

Magnetic sensors, in particular, anisotropic magnetoresistive sensors, are another kind of sensor that could be installed at the parking space to measure the disturbance in earth's magnetic field cause due to a vehicle parked at the parking space. Since almost all road vehicles have significant amounts of ferrous metals in their chassis, there is noticeable change in the earth's magnetic field due to their presence. This change in the magnetic field detected by the magnetic sensor is sufficient to detect the arrival or departure of a vehicle from the parking space.

Aside from detecting the occupancy of each space, a system could also count the number of vehicles entering or leaving a facility (or a specific zone or bay) to determine the availability of parking spaces within the facility (or a specific zone or bay).

In addition to using a specific sensor node to track one or more parking spaces, the system may leverage one or more sensor nodes in a collaborative fashion to determine the availability of a set of parking spaces. Information from these different sensor nodes may be processed in a distributed fashion to reinforce observations as well as eliminate false negative or false positive observations. The communication layer component is responsible for handling the continuous data stream generated by sensor nodes, and determining the parking guidance information within each direction in a parking facility. The use of wireless communication saves significant costs that would otherwise arise from laying communication cables. Moreover, the use of wireless communication rapidly facilitates the deployment of the application to parking facilities of varying structure and scale. For instance, the system may be deployed in indoor or outdoor parking facilities, incline ramps, multilevel facilities, basement facilities, or street parking.

The wireless network includes multiple conceptual entities that need to communicate with each other. These entities include the sensors, processors, routers, and sinks. The sensors produce the data. The processors compute this data to determine parking space availability for individual spaces or on an aggregate basis. The routers transfer this information to the sinks, which consume the data. The entities may reside on different physical computing elements or may be combined together on the same computing element.

The communication within the network can be categorized into guidance application communication or infrastructural communication. Guidance application communication relates to the transfer of sensed occupancy data with the goal of informing the sinks of parking availability information. Infrastructure communication refers to the communication needed to configure, maintain, and optimize operation. Because of the ad hoc nature of wireless networks, the data routing nodes must be able to discover paths to the sinks. Thus, infrastructure communication is needed to keep the network functional, ensure robust operation in dynamic environments, and optimize overall performance.

There are a variety of possible network topologies. Choice of a network topology depends on how the entities are deployed, the wireless technology chosen to connect the entities, cost of network installation, and the design complexity of the communication architecture. Diverse wireless technologies may be used to form a heterogeneous network. Moreover, the network may be a pure wireless network or a combination of a wired and wireless network. Some examples of network topologies include single hop network, heterogeneous hierarchical network, and multihop mesh network.

In a single hop network, entities can directly communicate with each other using Wi-Fi, Ethernet, or long range radio links such as WiMAX.

In a heterogeneous hierarchical network topology, the entities are connected by single or multiple hops to each other. The routers play a key role within the network to facilitate the exchange of messages via multiple hops. Different network hops could utilize different communication technologies. For example, the processors could use low power, short range links such as 802.15.4 or Bluetooth to communicate with the routers who may in turn use technologies like Institute of Electrical and Electronics Engineers 802.11 (IEEE 802.11) or WiMAX to communicate with sinks.

A multihop mesh network comprises of a network of nodes that contain sensors, processors, as well as routers and form a peer-to-peer ad-hoc wireless network as well as generate events related to vehicle detection. The nodes in this topology forward their own data as well as their neighbors' data towards the sinks. If the destination nodes are outside of the source node's radio range, the source uses intermediate nodes to forward data towards the destination node. A network is dense enough to have sufficient intermediate nodes to relay data between source destination pairs separated by multiple hops. Depending on network density, average node separation, expected data rate, the network may use low power 802.15.4, Bluetooth wireless technology, long range 802.11 links, or other technology to form the mesh network.

The parking guidance information presentation component presents parking guidance information to end users via variable message signs or on the Internet. A variety of physical displays including LED, LCD, or fiber based display, or combinations of these, may be used to present real-time information to the visitor. Depending on the capability of the signs used, appropriate alphanumeric messages and symbols can be flashed on the display screen to guide the visitor to the closest available spot. For example, a sign may simply show the count of available spaces, and if all spaces are occupied, the display may flash the sign “FULL.” The displays may include dynamic signage as well as user friendly navigation facilities to visitors.

The displays may also be manually controlled via a server to present other custom information. For example, while some displays may show parking availability information, other displays may be manually overridden to show advertising messages, public safety messages, special event messages, or other information. Each sign may be easily configured via an intuitive web browser based interface, thus reducing the manual labor associated with parking zone control. This feature may also be leveraged to indicate fixed routes, special reservations, or parking area closures for maintenance work. For example, traffic control inspectors can streamline heavy traffic flow with the appropriate messages flashed on the displays.

In one implementation, the system may be set up with dynamic informational signage to guide visitors at key decision points along anticipated routes to an available parking space. For example, signs on a freeway or road can direct a visitor to the right entrance as they approach the parking facilities. Signs at the parking facility entrance can summarize availability within the facility. Overhead signs at each parking level or zone can indicate the number of spaces available in each aisle. There is no limitation on the number of guidance signs that are installed as part of a system deployment.

In an implementation, the system may take into account the number of circulating vehicles in the parking facility in addition to vehicles already occupying spaces in calculating an accurate number of available spaces. This is especially useful during busy hours when some parking zones are almost full and contain a fair amount of circulating traffic. The display boards can display both the actual and anticipated count of occupied spaces. The incoming traffic can automatically be directed to parking zones with a larger percentage of available spaces.

In an implementation, the guidance related data is sent to a central server and data repository. The software server makes the data available to end users via a browser-based monitoring console. The console displays elaborate views of the entire parking lot. These views may include the parking lot layout with display locations showing their current available space counts and individual parking spaces showing their current occupancy status. The monitoring console may also be viewed from PDAs or other devices by parking facilities personnel to review parking activity.

Administration and management tools control, configure, and manage the components described above. Diagnostic or network management tools monitor network health and identify malfunctioning nodes. These tools provide summarized and detailed views of the entire network topology to verify that nodes are connected and functioning properly and to ensure that the network communication is reliable. Diagnostic tools also help to detect any network partitions and wireless interference. Some diagnostic tools have packet snooping and probe tools installed on laptops and PDAs to study network activity in a particular geographical region of the deployment to perform trouble shooting tasks or identify networking bottlenecks. Network management tools may collect data related to residual energy level of any battery powered nodes and provide this information for routine maintenance of the system.

System Architecture

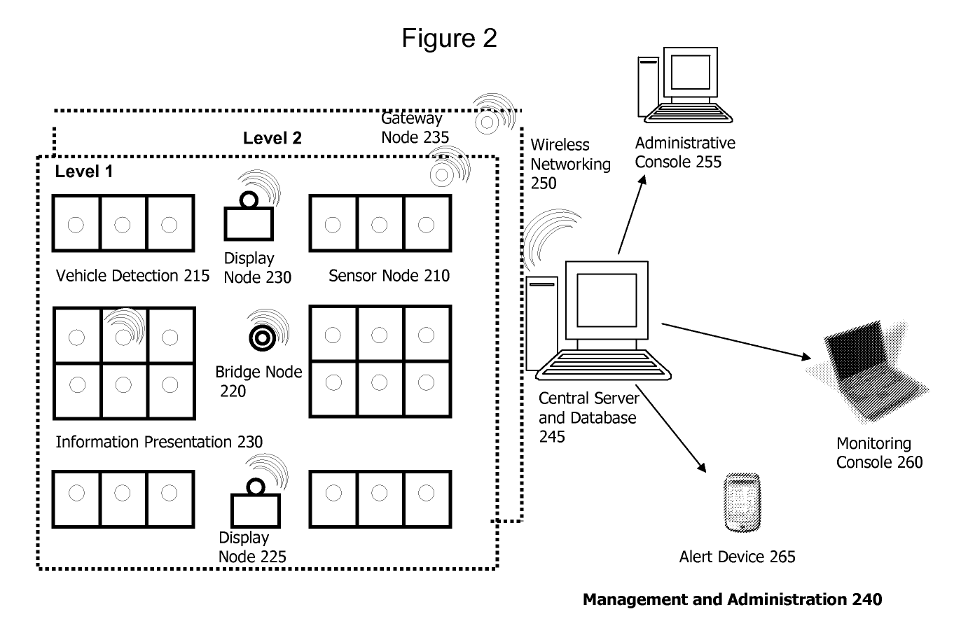

FIG. 2 shows a system architecture of a parking management system. The figure shows a specific embodiment in which the parking facility is a two-story structure. In other implementations, the parking area may be a single-level structure or multilevel structure, which may have more than two levels, such as three, four, five, six, seven, eight, or more. The structure may be outdoor or indoor, or a combination of these. A parking area or portion of a parking area may be above or below ground, or both. The parking area may be city or residential streets, such as in San Francisco or Palo Alto, Calif. or New York, N.Y.

In FIG. 2, the system includes sensor nodes 210 to form an intelligent vehicle detection system 215. There are bridge nodes 220, display nodes 225 (forming an information presentation system 230), gateway nodes 235, and a management and administration system 240. In various implementations of the invention, any component of the system may be split into multiple components or different components may be combined into a single component. A parking facility may also include further components not shown.

In a specific implementation, a management and administrative system may include a central server and database 245 (also know as root node) which stores data collected from the wireless network of sensor nodes, bridge nodes, and display nodes. The central server may host software to provide parking guidance, administration, and network health and management data to an administrative console 255. Using the administrative console, a user can monitor, manage, and administer parking activity. The central server may host software to also provide data into a monitoring console 260 or an alert device 265, or both of these.

The monitoring console may be a computer or similar device. This computer may be a desktop or laptop computer, or may be a handheld device like a personal digital assistant (PDA) or smart phone. The alert device may be a portable or handheld device such as a PDA or smart phone.

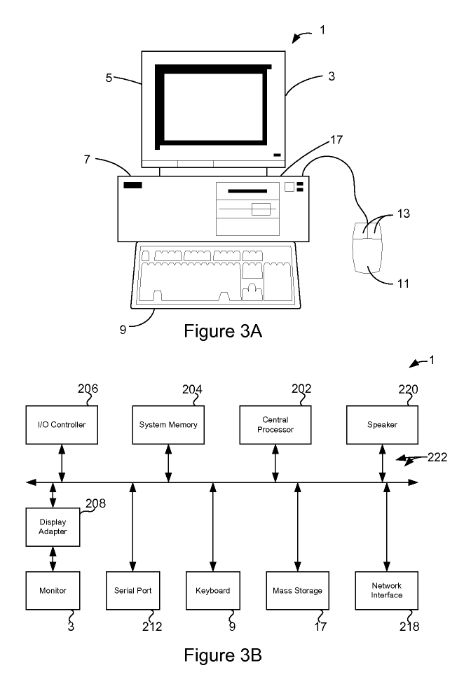

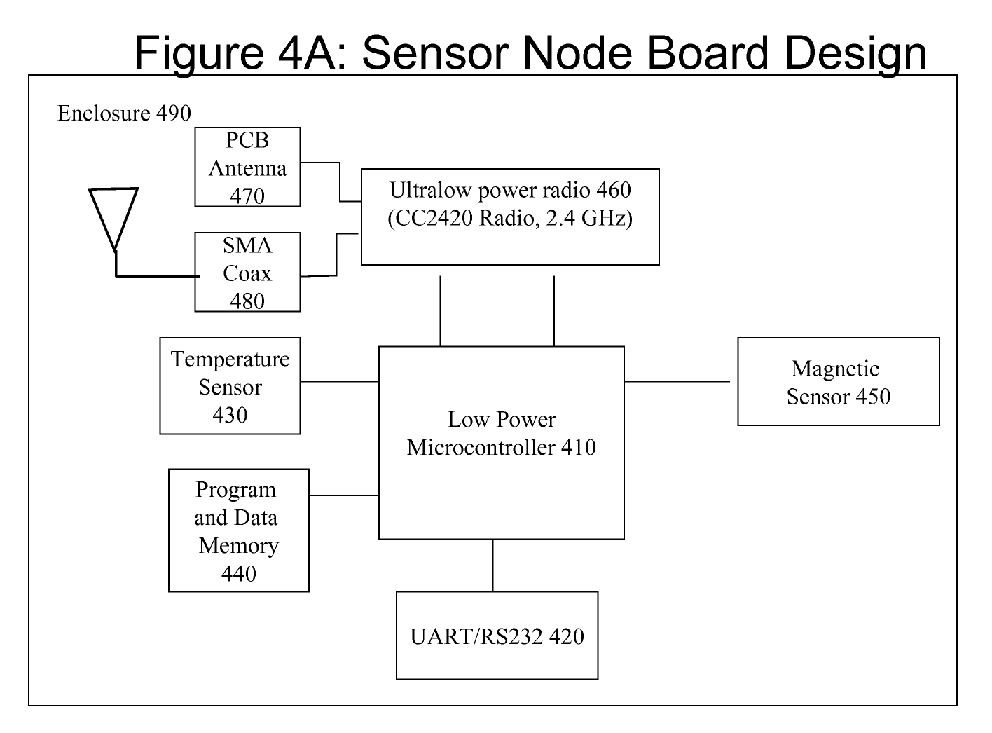

FIG. 3A shows a computer system 1 that includes a monitor 3, screen 5, cabinet 7, keyboard 9, and mouse 11. Such a computer system may used in the administration and operation of a parking system of the invention. Mouse 11 may have one or more buttons such as mouse buttons 13. Cabinet 7 houses familiar computer components, some of which are not shown, such as a processor, memory, mass storage devices 17, and the like.

Mass storage devices 17 may include mass disk drives, floppy disks, magnetic disks, optical disks, magneto-optical disks, fixed disks, hard disks, CD-ROMs, recordable CDs, DVDs, recordable DVDs (e.g., DVD-R, DVD+R, DVD-RW, DVD+RW, HD-DVD, or Blu-ray Disc), flash and other nonvolatile solid-state storage (e.g., USB flash drive), battery-backed-up volatile memory, tape storage, reader, and other similar media, and combinations of these.

A computer-implemented technique of the invention may be embodied using, stored on, or associated with computer-readable medium. A computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version, of the software of the present invention may be stored or reside in RAM or cache memory, or on mass storage device 17. The source code of the software of the present invention may also be stored or reside on mass storage device 17 (e.g., hard disk, magnetic disk, tape, or CD-ROM). As a further example, code of the invention may be transmitted via wires, radio waves, or through a network such as the Internet.

FIG. 3B shows a system block diagram of computer system 1 used to execute software of the present invention. As in FIG. 3A, computer system 1 includes monitor 3, keyboard 9, and mass storage devices 17. Computer system 1 further includes subsystems such as central processor 202, system memory 204, input/output (I/O) controller 206, display adapter 208, serial or universal serial bus (USB) port 212, network interface 218, and speaker 220. The invention may also be used with computer systems with additional or fewer subsystems. For example, a computer system could include more than one processor 202 (i.e., a multiprocessor system) or the system may include a cache memory.

The processor may be a dual core or multicore processor, where there are multiple processor cores on a single integrated circuit. The system may also be part of a distributed computing environment. In a distributed computing environment, individual computing systems are connected to a network and are available to lend computing resources to another system in the network as needed. The network may be an internal Ethernet network, Internet, or other network.

Arrows such as 222 represent the system bus architecture of computer system 1. However, these arrows are illustrative of any interconnection scheme serving to link the subsystems. For example, speaker 220 could be connected to the other subsystems through a port or have an internal connection to central processor 202. Computer system 1 shown in FIG. 3A is but an example of a computer system suitable for use with the present invention. Other configurations of subsystems suitable for use with the present invention will be readily apparent to one of ordinary skill in the art.

Computer software products may be written in any of various suitable programming languages, such as C, C++, C#, Pascal, Fortran, Perl, MatLab (from MathWorks, Inc.), SAS, SPSS, Java, JavaScript, and AJAX. The computer software product may be an independent application with data input and data display modules. Alternatively, the computer software products may be classes that may be instantiated as distributed objects. The computer software products may also be component software such as Java Beans (from Sun Microsystems) or Enterprise Java Beans (EJB from Sun Microsystems).

An operating system for the system may be one of the Microsoft Windows® family of operating systems (e.g., Windows 95, 98, Me, Windows NT, Windows 2000, Windows XP, Windows XP x64 Edition, Windows Vista, Windows CE, Windows Mobile), Linux, HP-UX, UNIX, Sun OS, Solaris, Mac OS X, Alpha OS, AIX, IRIX32, or IRIX64, or combinations of these. Other operating systems may be used. A computer in a distributed computing environment may use a different operating system from other computers.

Furthermore, the computer may be connected to a network and may interface to other computers using this network. For example, each computer in the network may perform part of the task of the many series of steps of the invention in parallel. Furthermore, the network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, and 802.11n, just to name a few examples). For example, signals from a computer may be transferred, at least in part, wirelessly to components or other computers.

In alternative implementations of the invention, the database may be a distributed database, where certain data is provided to particular devices or consoles. The database may be a relational, flat, or hierarchical database. The database may be stored in a single file or using multiple files. Some of the database files may reside on different machines, or all files may be on the same machine. For example, portions of the database may be stored on a portable or handheld device, such as a PDA.

In other implementations, the administration, monitoring, enforcement, and other tasks may be incorporated into a computer system in which the central server and database also reside. In other implementations, the information from the central server and database may be provided to distributed devices such as PDAs or electronic kiosks that perform designated functions.

In an implementation, sensor nodes, bridge nodes, and display nodes form a wireless network. In one implementation, each parking space has a sensor node to detect the presence or absence of a vehicle in a parking space. In other implementations, a single sensor node may detect vehicles in more than one parking space or multiple sensor nodes may detect vehicles within a single parking space.

In one implementation, bridge nodes relay the information from the sensors to display nodes and gateway nodes in real time. Display nodes are updated in real time. Bridge nodes actively participate in networking protocols to aggregate data from the sensors, compute information, and send results to display nodes and gateway nodes. Bridge nodes are generally placed in locations to optimize communication with sensor nodes, gateway nodes, and display nodes. In another implementation, bridge nodes may not exist and the sensor nodes may create a multi-hop mesh network among themselves to transmit messages to gateway nodes and display nodes.

In one implementation, display nodes are electronic variable message signs located at strategic positions in the parking structure. For example, the displays may be located at key intersections of the parking facility, to inform visitors about space availability as they navigate through the facility. The display nodes are typically mounted above the ground and closer to the ceiling for easy visibility to visitors. The displays may also be hung from the ceiling, mounted on or hung from vertical walls, posts, and other locations that may provide easy visibility.

In one implementation, gateway nodes interface with the central server and the rest of the wireless network deployed to enable the monitoring of parking activities. The central server receives continuous data feeds from the network related to parking guidance, administration, network health and management, and stores them in the central database. The server supports an intuitive web browser based interface that can be used to monitor parking activity, manage, and administer parking operations from a centralized location. In another embodiment, monitoring, management, and administration of parking operations may be distributed across multiple servers.

Sensor nodes are installed in parking spaces to provide accurate vehicle presence measurements. In an embodiment, a parking management system uses magnetic sensors installed at parking spaces to detect vehicles. In other implementations, the sensor node may use other sensor technologies, such as ultrasonic, electromagnetic wave or impulse, laser, optical, infrared, acoustic, physical or mechanical switch, sound, temperature, pressure, or some combination of sensor technologies. A system of the invention may include sensors using any combination of technologies.

In a specific embodiment, the sensor is embedded on a battery-operated printed circuit board that also contains a microcontroller and a radio for wireless communication. This entire package may be referred to as a sensor node. In alternative embodiments, the board may be powered by line power. For example, the board may be primarily line powered and then the battery is for back-up purposes in case there is a power failure. A system of the invention may include sensors using wireless, wired, or both.

In the case where the sensor node consumes relatively low power (which is generally desirable to reduce maintenance), a battery may power the sensor and accompanying circuitry for many years, without needing to replace the battery. A battery may last, for example, for five or ten years or more without replacement. Further, the sensor may be powered by power sources such as solar cells. The solar cells may be used to recharge a battery. A system of the invention may include sensor nodes that are powered differently from each other. Some sensor nodes may receive line power while other sensors receive battery power.

Instead of wireless communication, a sensor node may use a wired network for data communication. A system of the invention may include some sensor nodes which are wired and others that are wireless. Regardless of how the sensor node communicates its data, wirelessly or wired, its power source may vary (e.g., battery or line). Further, in some embodiments, the wire for data communications may also be used to power the sensor node (e.g., power over Ethernet).

In a specific implementation, the board is housed in a robust, environmentally-sealed enclosure that is unaffected by weather and lighting conditions. However, the board may be housed in any enclosures as dictated by the environment to which the board and sensor will be subjected. For example, an outdoor-located sensor may be weatherproofed and made resistant to ultraviolet radiation. A sensor to be located on the ground may be made especially durable because it might be run over by a sports utility vehicle (SUV).

In other implementations, the placement of the sensor nodes in the proximity of the parking spaces may vary based on the sensor node's capabilities as well as the layout of the parking spaces. For example, there could be multiple cameras monitoring the same parking space, or a single ultrasonic sensor responsible for an individual parking space. In an embodiment, the packaged sensor unit may be extremely easy to install, enabling low cost, and rapid deployment of the sensor nodes.

In one implementation, the sensor nodes have short radio range as it uses a low power radio. In order to increase the effective wireless range of sensor nodes, a bridge layer containing bridge nodes collects sensor data from sensor nodes and relays the data to the geographically widespread display nodes. The bridge nodes form the core wireless network with sensor nodes at the edge of this core network. In another embodiment, sensor nodes could communicate directly with display nodes using high bandwidth or long range links, such as 802.11 wireless links or WiMax radio links at the sensor nodes. In yet another embodiment, sensor nodes may form a peer-to-peer mesh network among themselves and leverage multihop message communication to deliver messages to displays.

Design of Intelligent Vehicle Detection and Parking Space Monitoring

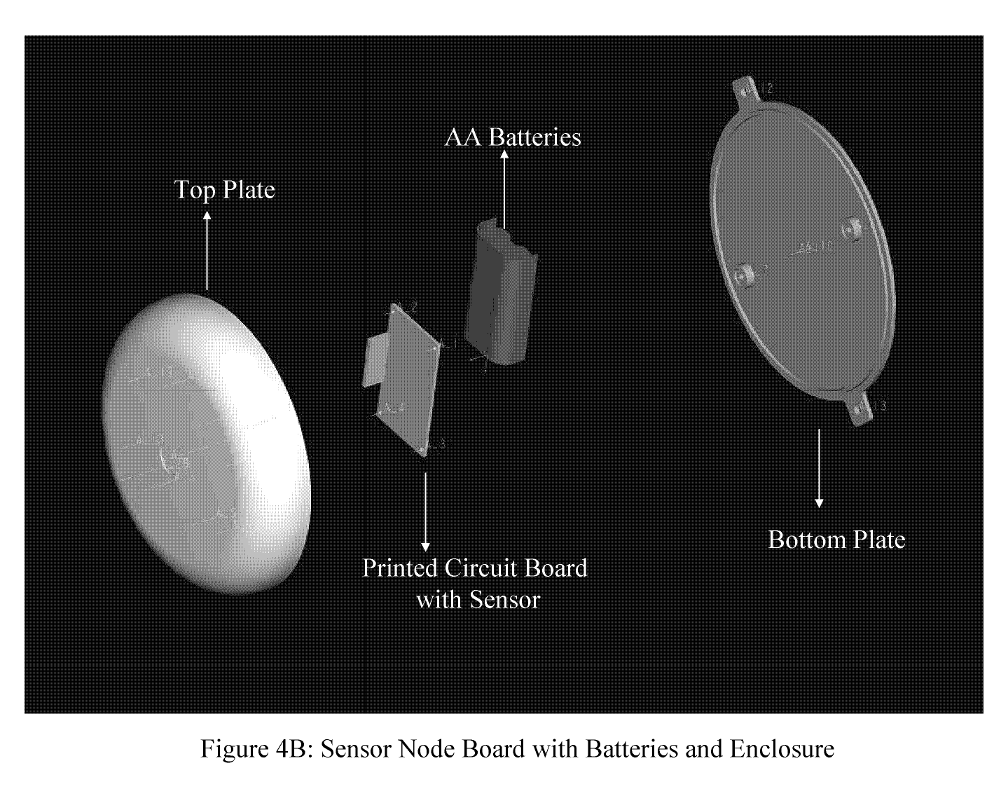

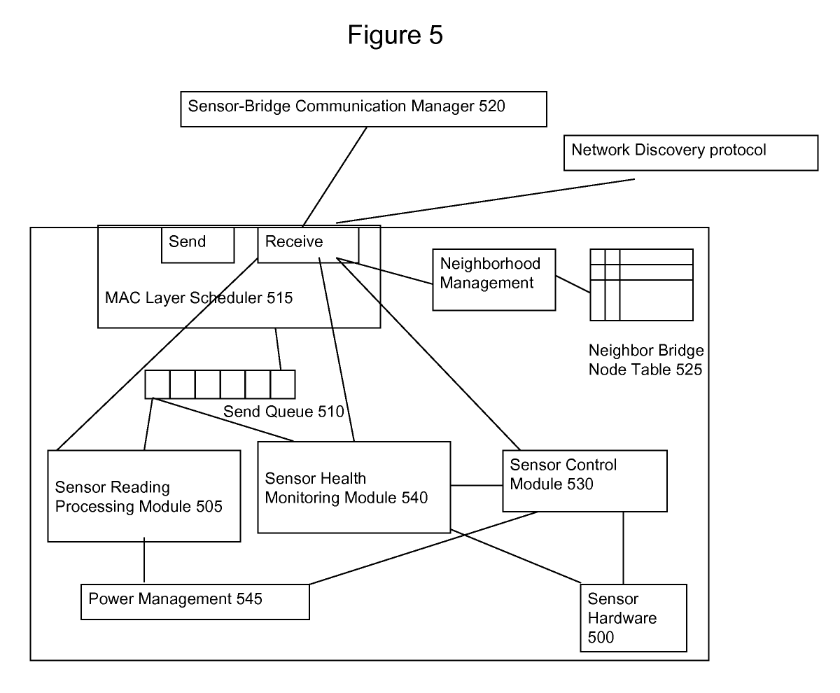

FIG. 4A shows a functional schematic diagram of a board design of a sensor node. The key elements of the sensor node hardware include a board with the following components:

(a) a microcontroller 410 such as Texas Instrument's MSP430 or LPC 935 from Philips Semiconductor, connected to a Universal Asynchronous Receiver-Transmitter (UART) using the RS232 standard 420, a temperature sensor 430, and program and data memory 440.

(b) a magneto-resistive (MR) sensor 450, such as Honeywell's HMC 1022 or HMC 1043 connected to the microcontroller.

(c) a radio frequency (RF) transceiver 460 such as Chipcon 2420, connected to a printed circuit board (PCB) Antenna 470 and SubMiniature version A (SMA) RF connector 480.

(d) a battery pack.

(e) an enclosure 490.

FIG. 4B shows the sensor node hardware. The printed circuit board, a sensor and a battery pack is encased in an enclosure with a top plate and a bottom plate. The sensor node enclosure is robust, environmentally-sealed, and protects the sensor board from weather, water, oil, humidity, and lighting conditions. The board may be housed in any enclosure as dictated by the environment to which the board and sensor will be subjected. For example, an outdoor-located sensor may be weatherproofed and made resistant to ultraviolet radiation. A sensor to be located on the ground may be made especially durable because it might be run over by a large sports utility vehicle (SUV). Such an enclosure may be made of a non-magnetic durable material such as the Lexan polycarbonate compounds manufactured by GE Plastics. The enclosure material may not interfere with the sensor node's wireless communication. Moreover, the enclosure may be openable to allow for the replacement of batteries.

The sensor node hardware is designed to operate on very low power. Since the nodes run on batteries, they are designed with some key features to maximize battery life.

The microcontroller supports “sleep” mode, allowing for minimum power consumption when the node is in an inactive state for a certain amount of time. During “sleep” mode the microcontroller is inactive and consumes very little power (only a few microamps).

The embedded software controls the mode of the microcontroller and decides when the microcontroller should be active and when it should be in “sleep” mode. Moreover, the software determines when the RF transceiver should be turned on and when it should be switched off. The RF transceiver is switched on only when the sensor node needs to communicate and is switched off otherwise. Additionally, the embedded software determines when the magnetic sensor is turned on and when it is switched off. The magnetic sensor is turned on only when the sensor node is required to measure its local magnetic field. The sensor node is based on a modular hardware design that allows for power consumption to be optimized by only powering the elements selectively.

Software on board can obtain digital values of the sensor output.

In one embodiment, the RF transceiver supports an RF range up to 100 feet. In other embodiments, the RF range may be greater than 100 feet. In other embodiments, a power amplifier may be used to increase the transmission range of the sensor node.

In one embodiment, the RF transceiver operates in the frequency band of 2.4 gigahertz. In other embodiments, the RF transceiver may operate at frequencies lower or higher than 2.4 gigahertz.

In one embodiment, the sensor circuit is active or powered only when required for sampling sensors and communicating messages.

In one embodiment, a two-axis magnetometer may be used to detect the presence of a vehicle in a single parking space. During installation of the sensor node, the placement of the node is such that one axis (e.g., X axis) of the sensor is parallel to the length of the vehicle and the other axis (e.g., Z axis) measures the vertical magnetic field.

In one embodiment, high capacity, small form factor batteries power the node. In other embodiments, other types of batteries or other methods, such as solar power may be used to power the node.

Since the reliability of the sensors readings is affected by environmental conditions such as temperature. The embedded software offsets the observed reading by the expected error margin to obtain a more accurate value of the sensed parameters. The circuit includes a temperature sensor to compute the offset in readings caused by external climate conditions.

In one specific implementation of the invention, activities such as sensing, communication, data processing, and listening to the wireless medium for messages have been optimized to reduce power consumption. At the sensor node level, battery life is optimized through minimization of the number of transmissions and periodically switching off the radio. A data packet for transmission to the bridge layer is generated only when the sensor readings are processed and confirm a change in the occupancy state of a parking space. For example, a data packet is generated only when the occupancy status of a parking space changes from occupied to empty or from empty to occupied. The radio at the sensor node is turned off when it does not need to communicate.

In one implementation of the invention, the execution environment at the sensor nodes is assembly language. In another implementation, the execution environment may be a higher level programming language. The microcontroller at the sensor node has few software registers to store the necessary configuration parameters and enough memory to store and execute the code and sensor readings.

Software Design of Sensor Nodes

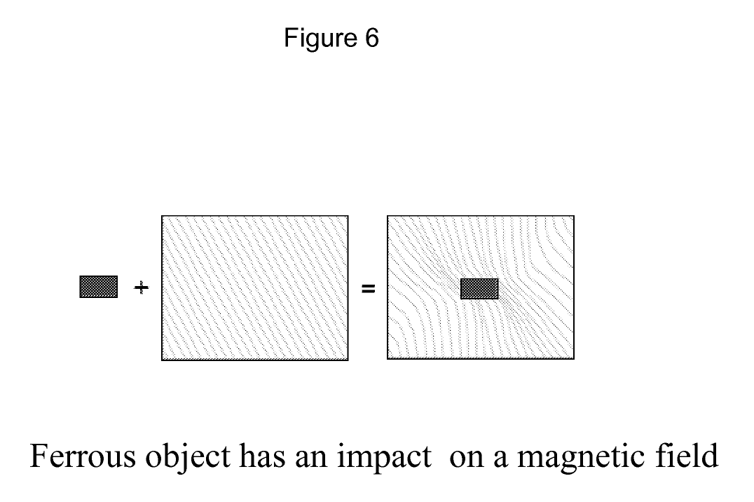

FIG. 5 shows a block diagram depicting the interaction of software modules at the sensor node. The interacting components include the sensor hardware 500, a Sensor Reading and Processing module 505, a send queue 510, a MAC layer scheduling module 515, a Sensor to Bridge communication manager 520, a neighbor bridge node table 525, and a sensor control module 530. When there is an event to report, the sensor sends data to the reading and processing module. The reading and processing module relays the data to the send queue. The send queue buffers the data before the MAC scheduling module schedules transmission of the data packet to a neighboring bridge node from the neighbor bridge node table via the sensor-bridge communication manager. Power management 545 conserves energy at the sensor control module and the sensor reading and processing module. The sensor health monitoring module 540 collects health parameters on the sensor nodes and sends the information to bridge nodes.

After installation, the sensor nodes are calibrated to use the earth's magnetic field as a baseline to identify with a no-vehicle scenario. These calibrated readings are automatically adjusted to the midpoint of the scale to help measure the widest possible deviations above and below the baseline readings. The sensor nodes run a network discovery protocol to populate the neighbor bridge node table with neighboring bridge nodes. The sensor-bridge communication manager at the bridge node also synchronizes the time between the sensor node and the bridge node.

In other implementations of the invention, two or more modules and protocols may be combined into a single module or protocol, or a single module or protocol may be divided into multiple modules and protocols. Additionally, the sensor control module may be incorporated into the sensor hardware.

Sensor nodes periodically detect the presence or the absence of a vehicle in a parking space. This sensing interval can be configured to improve overall accuracy of guidance information. In one configuration, the sensing interval can be set to one second. At the end of the sensing interval, the sensor readings are processed by the sensor reading and processing module to determine if the occupancy status of the parking space has changed. If there is no change in the occupancy status, no event is generated. If there is a change, a valid event is generated and then buffered at the send queue for transmission to the bridge node.

Sensor nodes discover bridge nodes in their neighborhood shortly after network installation, and store them in a local database, or the neighbor bridge node table. They select the node with best link quality as the parent bridge node. If there is an event to report at the end of a sensing interval, sensor nodes schedule transmission to their parent bridge nodes during a time interval called M2B frame in the MAC layer. The MAC layer will be explained in a later section. The MAC layer is implemented at both sensor nodes and bridge nodes. The MAC layer schedules time periods for sensor node to bridge node as well as bridge node to bridge node communication.

The event transmission from the sensor node is sent to the sensor-bridge communication manager in the parent bridge node. After event transmission, the sensor node waits for an acknowledgement packet (or ack) from the bridge node. If the sensor node fails to receive an acknowledgement packet within an acknowledgement packet timeout interval, the sensor node will retransmit the event packet. In an alternative embodiment, the sensor node may use an exponential back-off scheme to retransmit the event packet. Time synchronization occurs at the sensor node to ensure reliable scheduling of the M2B frames. The parent bridge node is responsible for sending time synchronization messages to the child sensor node to make sure the sensor node's local time does not drift away from the bridge node's local time.

The sensor control module sets and controls configuration settings such as sensor calibration, software thresholds for sensor readings to detect occupancy of a space, and control parameters such as the sensing interval. The sensor health monitoring module is responsible for collecting and sending periodic health parameters, such as residual battery power, radio link quality with its neighbors, sensor state as well as sensor hardware malfunction information to the parent bridge nodes. The bridge nodes further route this data as part of the network health and management data to the central server that can make the data available to the administrative console.

In one implementation, the system may support network programming to transmit program code wirelessly from a bridge node to a sensor node. The program code is loaded into the sensor node from the bridge node, and the sensor node executes the new code. Network programming saves the efforts of uninstalling and reprogramming each sensor node manually.

Parking Space Occupancy Monitoring

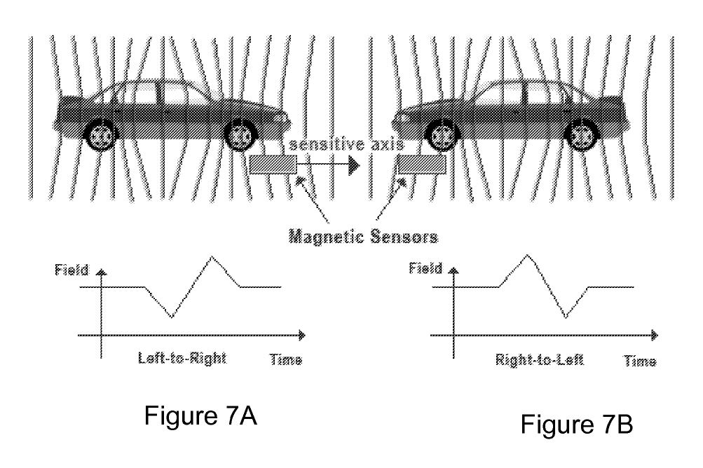

FIG. 6 shows a ferrous object causing a disturbance in a uniform magnetic field. When a vehicle occupies a parking space, it creates a local disturbance to the earth's magnetic field around the parking space. A magnetic sensor can sense this disturbance by processing the changes in the readings along each magnetic axis and detect that the parking space is occupied. The magnetic sensor uses the earth's magnetic field as a baseline to identify with a no-vehicle scenario. As a vehicle parks in the proximity of the sensor, the sensor detects a sudden non-transient shift in its local magnetic field away from its baseline (no-vehicle) value.

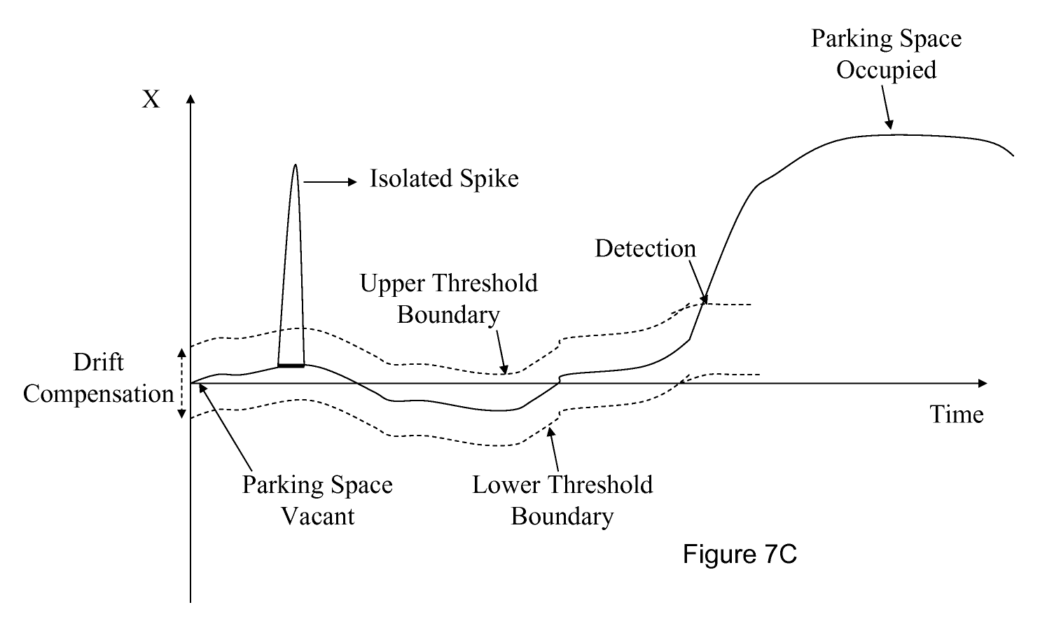

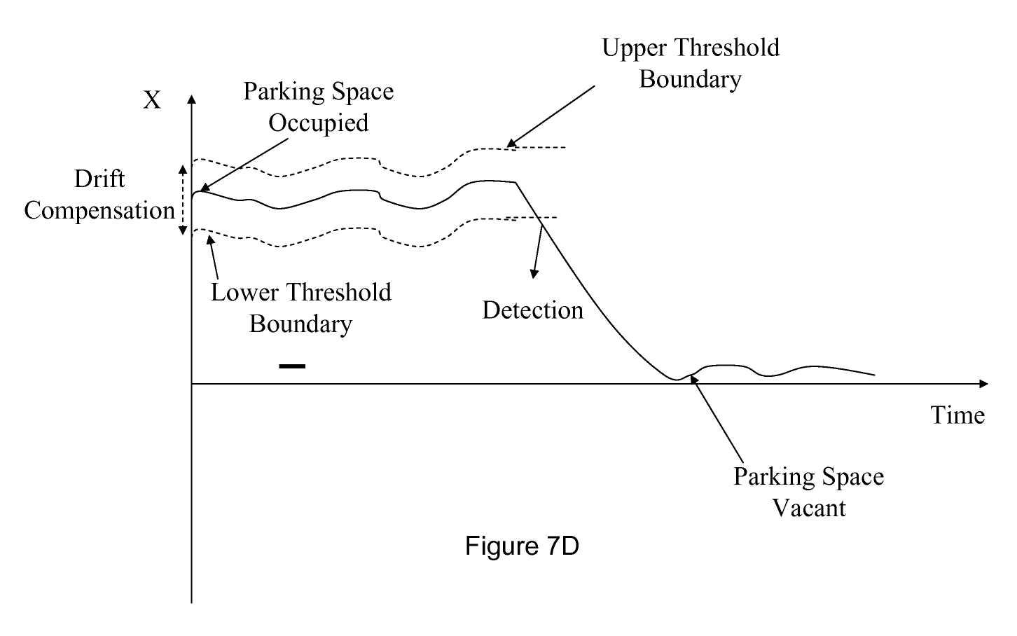

FIGS. 7A and 7B shows the presence of a vehicle and the direction detection by the sensor in one particular implementation. FIG. 7A shows sensor output curve as a car moves from left to right and FIG. 7B shows the curve as the car moves from right to left. When the car is directly inline with the sensor, the magnetic variation through the car looks the same as the starting point and the sensor output curve returns to the initial value. FIG. 7A shows the sensor output curve as a car moves from left to right. As the car moves to the right, the flux lines bend away from the car, causing the sensor output to decrease from its initial value. When the car is out of the range of the sensor, the sensor output returns to its initial value.

In FIG. 7B, as the car moves from right to left, the flux lines bend toward the car in the positive sensor axis, causing the sensor output to increase above the initial value. When the car is out of range of the sensor, it will again return to the initial value. By detecting and keeping track of the vehicles moving in each direction, the sensor nodes can count the number of vehicles entering and leaving a parking facility. The difference in these counts provides the number of vehicles in the lot which can be used to estimate the number of available parking spaces in the lot.

FIGS. 7C and 7D shows how a sensor node compensates for drifts in its magnetic readings. To accurately sense stationary vehicles, the sensor nodes must compensate for the changes in the magnetic readings due to drift. The drift in the readings can arise from small changes in the magnetic field that occur on an ongoing basis. Drifts can also arise from temperature changes that impact the sensor's readings. Not compensating for drift can lead to erroneous readings on whether a vehicle is present.

In one embodiment, a software algorithm can detect small, slow changes in the magnetic readings and reject them. The algorithm could measure the earth's field bias value and set upper and lower thresholds based on a fixed amount for a desired detection range. As shown in FIG. 7C, the upper and lower thresholds are continuously set to compensate for thermal drifts and magnetic field drifts. As a vehicle approaches the sensor, magnetic readings change faster than the drift compensation algorithm is allowed to shift, thus resulting in a valid vehicle detection.

After the vehicle has finished parking in the space, new upper and lower drift compensation thresholds are continuously set as shown in FIG. 7D. When a vehicle leaves, the magnetic readings change faster than the drift compensation algorithm is allowed to shift, thus resulting in a valid vacant parking space detection. After a vehicle leaves, the magnetic sensor is pulsed with high currents to enable it to clear any remnant flux and to help it perform accurate measurements of its local magnetic field.

The software algorithm also compensates for sudden, transient, short-lived changes in magnetic readings that correspond to isolated spikes. An isolated spike may be characterized as a rapid rise and fall (or fall and rise) in magnetic readings within a very short period of time such as for less than one second. An approach is to set the thresholds based on a moving average over a particular time period of the sensor reading. By using a moving average, sudden changes in the sensor signal such as because of noise (e.g., car starting its engine) will not be followed in the threshold.

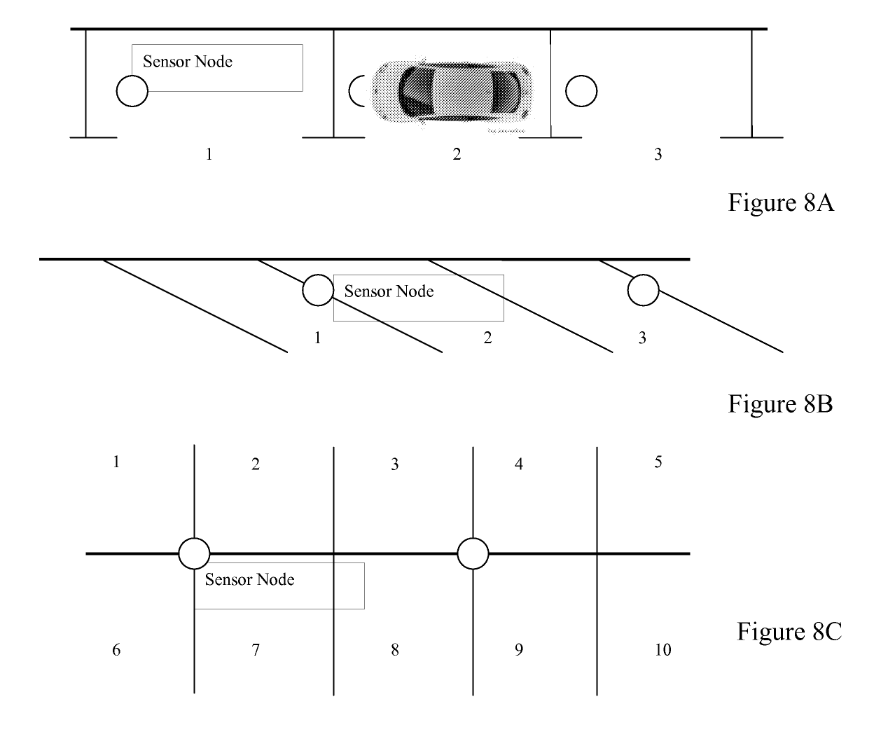

FIGS. 8A to 8C show three examples of parking layouts with magnetic sensors to detect space occupancy. In other implementations, other types of sensor technologies, such as ultrasonic, cameras, electromagnetic wave or impulse, laser, optical, infrared, acoustic, physical or mechanical switch, or pressure may be used. A single sensor node may detect the occupancy status of one or more parking spaces. In FIG. 8A, a single sensor tracks the occupancy status of one parking space. In FIG. 8B, one sensor tracks the occupancy status of two parking spaces. In FIG. 8C, a single sensor tracks the occupancy status of four parking spaces.

The sensor is calibrated to record the earth's local magnetic field. Then, if a vehicle occupies a particular parking space, the sensor detects the magnitude and direction of the change in its local magnetic field to identify which one of the parking spaces it is monitoring is occupied. The sensor node periodically samples its local magnetic field at high frequency and continuously tracks the occupancy status of its parking spaces. As vehicles enter and exit the spaces, the sensor records the magnitude and direction of the change in its local magnetic field to identify which one of the parking spaces it is monitoring underwent a change in occupancy status.

In other implementations, sensor nodes may collaborate with each other to enhance the accuracy of data sensed by individual sensors. Sensor readings related to parking space occupancy may be exchanged among multiple nodes in the proximity of that space. Such local collaboration can provide more accurate results compared to independent inferences drawn based on individual sensor's readings.

In another implementation, the sensor nodes may determine the number of available parking spaces in a particular parking lot, or area, or zone, by counting the vehicles entering and exiting the lot, area or zone. When a vehicle passes close to the magnetic sensor, or drives over it, the sensor will detect the variation in the magnetic field from various parts of the vehicle. A three-axis magnetic sensor placed in the lane of traffic will provide a rich signal output for vehicles passing over it. The axis along the direction of travel can be used to determine the direction of the vehicle. When there is no car present, the sensor will output the background earth's magnetic field as its initial value. As a car approaches, the earth's magnetic field lines of flux will be drawn toward the ferrous vehicle. In one implementation, if the sensitive axis of the magnetic sensor points to the right and the car is traveling left to right, then the magnetic sensor will initially see a decreasing field as more flux lines bend toward the oncoming car. That is, the first magnetic deviation from the sensor's initial value will move in the negative direction.

An implementation may use one of the above methods to track the occupancy status of the parking facility or it may employ any combination of methods. Additionally, different sensor technologies may be used in addition to the methods described above to monitor the occupancy status of the parking facility. For example, in one implementation camera based sensors may be used in addition to magnetic sensors to monitor parking space occupancy.

Design of Communication Layer for In-Network Computation and Communication: Hardware Design of Bridge Nodes

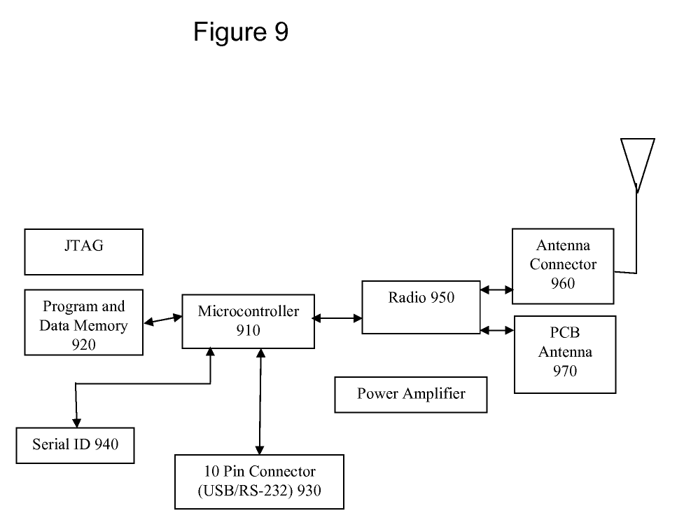

FIG. 9 shows a functional block diagram of a bridge node in a specific embodiment. Bridge nodes are equipped with a microcontroller 910 containing a serial identification (ID) 940. The microcontroller is connected to a ten-pin connector 930 and program and data memory 920. The microcontroller is also connected to a wireless radio 950 coupled with an antenna connector 960 and a PCB antenna 970. These devices or nodes may be line powered, battery powered, or powered through renewable sources of energy such as solar cells.

Bridge nodes form an underlying backbone network that connects sensor nodes to display nodes and gateway nodes. In an implementation, bridge-node radios form a short-range communication network with an average radio range of 50 meters to 100 meters. The range of the bridge node radio has an impact on where bridge nodes are located and how close bridge nodes will be next to each other. The range of a bridge node may vary. For example, the range may be greater than 100 meters. The range of a bridge node may be less than 50 meters. A spatially well-connected network of nodes allows each node to be surrounded by multiple neighbors in their radio range.

Typically, bridge nodes have an available bandwidth of about 250 kilobytes per second. However, in other implementations, the bandwidth may be less than 250 kilobytes per second, or the bandwidth may be greater than 250 kilobytes per second. The greater the bandwidth, the larger the rate at which data can be sent through the network.

The microcontroller can support the processing and memory requirements of the various application level tasks and networking software. The bridge nodes can also communicate with a wireless-enabled PDA or laptop computer running appropriate diagnostic software. The bridge nodes are also equipped with flash memory so that in case of node failure it does not lose its configuration parameters and can reconnect with the network upon restarting.

In one implementation, the low power radios of the bridge nodes are omnidirectional and the presence of transient obstacles, such as rain and snow, and permanent physical obstacles, such as buildings, in the environment may affect their effective transmission range. To improve their transmission range in such cases, the nodes may use power amplifiers. The nodes are equipped with software link estimators to measure the quality of its radio link connection with neighboring bridge or sensor nodes. The link estimators are useful in determining the right separation between bridge nodes to maximize spatial reuse of the radio range, and to form a well connected wireless network after taking into account the loss of transmission range due to transient and permanent obstacles.

The Execution Environment

One implementation includes an embedded execution environment at the bridge node. An example of such an environment is TinyOS. TinyOS at the bridge nodes controls the different hardware components and provides the software platform to implement the data processing and networking software. TinyOS features a component-based architecture, which enables rapid innovation and implementation while minimizing code size as required by the memory constraints inherent in sensor networks. TinyOS's event-driven execution model enables fine grained power management while allowing the scheduling flexibility made necessary by the unpredictable nature of wireless communication and physical world interfaces. TinyOS already provides interfaces to various built-in devices such as radio power management and timer support. Other implementations may use an execution environment other than TinyOS such as Contiki (see A. Dunkels, B. Gronvall, and T. Voigt. Contiki, “A Lightweight and Flexible Operating System for Tiny Networked Sensors,” Proceedings of the First IEEE Workshop on Embedded Networked Sensos, November 2004, Tampa, Fla.) at the bridge node.

In one implementation, the gateway node uses the Linux operating system as the execution platform. The gateway node has storage to accept continuous data streams from the wireless network and buffer them in case its link to the central server experiences transient failures.

Communication Architecture

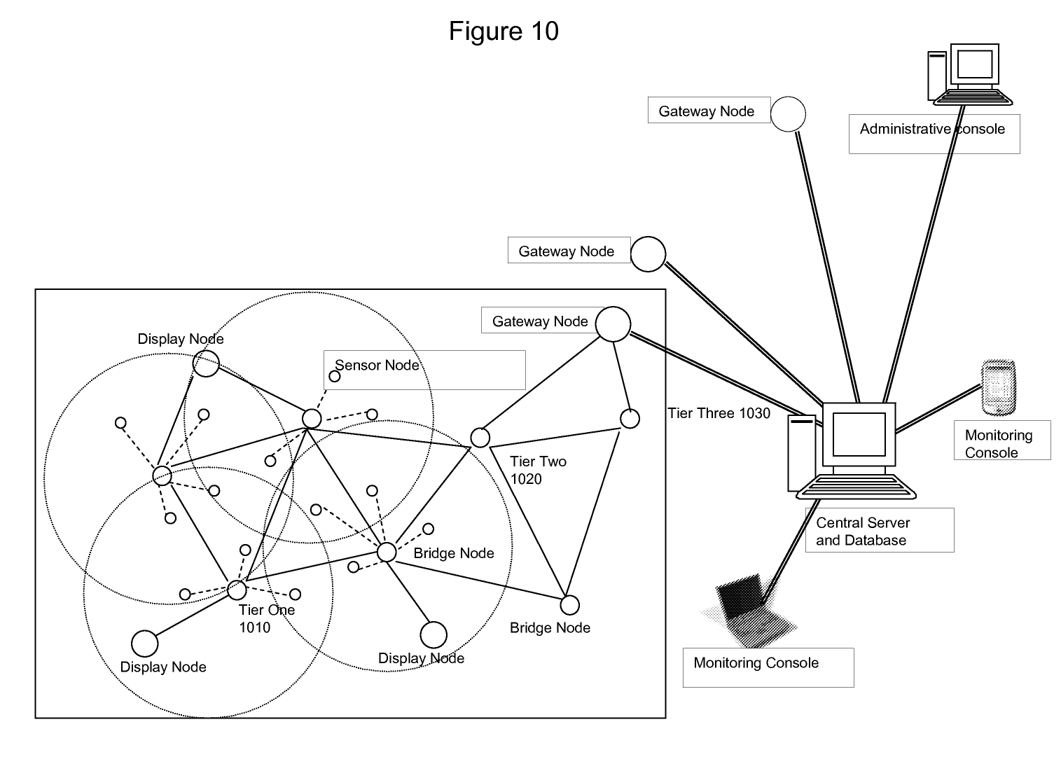

FIG. 10 shows a hierarchical organization of the network topology in one implementation. In an implementation, there are three main communication tiers. The bottom tier, or tier one 1010, is represented by the dotted lines, is the low power, single-hop communication between the sensor nodes and bridge nodes providing sensor data to the network.

The second communication tier is represented by solid lines 1020. The second tier is the low power, ad hoc multihop network among the bridge nodes to route data to destination display nodes and gateway nodes.

The double lines in FIG. 10 represent the third communication tier 1030. The third tier includes a wide area network link between the gateway nodes and the central server. Additionally, the third tier includes other links between the central server and its clients including the monitoring console and the administrative console. The links between the central server and its clients may be spread over a local or wide area network. In an implementation of the invention, the nodes and the clients may be geographically close to each other or separated by large distances. For example, the monitoring consoles may be spread over offices within buildings or may be mobile in the form of PDAs carried by traffic control personnel. Technologies such as General Packet Radio Service (GPRS), Worldwide Interoperability for Microwave Access (WiMAX), Ethernet, 802.11, or other wireless technologies may also be used to form the third communication tier of the wireless network.

In another implementation, the topology may be different. There may be less than three communication tiers, such as one or two, or there may be more than three communication tiers, such as four, five, six, seven, eight, nine, or ten or more.

In an implementation, sensor nodes at the bottom tier of the communication architecture are deployed in a dense manner such that the parking spaces being monitored are within their sensing range. The bridge layer network is sparse such that each bridge node is responsible for collecting data from a large number of sensor nodes in its radio range. Sensor nodes, also known as a “child sensor node,” typically report to bridge nodes, also known as a “parent bridge node,” that are geographically closest or have the best link quality over time. This ensures an even distribution of sensor nodes among the available bridge nodes. The “child/parent” relationship is dynamic during lifetime of the network. Sensor nodes select bridge nodes with the best bidirectional radio links at the current time as their parent bridge nodes.

In one implementation, manual placement of bridge nodes in the parking structure layout ensures that each bridge node has uniform spatial connectivity with its neighboring bridge nodes and is responsible for a large number of sensor nodes. Besides careful bridge node placement, validation by real deployment is important to account for loss in radio range due to physical obstructions such as buildings, metal bodies, mutipath fading, and poor connectivity.

In an implementation, the software complexity of the in-network computation and communication resides at the bridge nodes. Setting up the wireless network involves two phases.

The first phase is the bootstrap phase. The bootstrap phase consists of network discovery to form a connected network and initialize the associated data structures. The pseudo-code for the network discovery algorithm is as follows:

(i) When node A is turned on or reset, it sends a broadcast message with its location information and node ID.

(ii) A neighboring node B hears the broadcast message.

(iii) If node B finds that the node A is not present in its neighbor table, then node B sends a network discovery message to node A with node B's location information

(iv) Node A, on receiving the network discovery message, adds node B to its neighbor table along with node B's location information

(v) Node A sends an acknowledgement message to node B which contains node A's location information

(vi) On receiving the acknowledgement message, node B adds node A to its neighbor table along with node A's location information

(vii) Network discovery is a continuous process and the health of the link to each neighbor is maintained in the neighbor table.

During network discovery, bridge nodes broadcast their identities in their neighborhood and receive identity broadcasts from their neighbors to initialize their neighbor tables. After a few iterations of exchanging network discovery broadcasts, a well connected bridge node network is formed.

During network discovery, sensor nodes also broadcast their identities and wait for neighboring bridge nodes to respond. The sensor nodes maintain a list of candidate parent bridge nodes in their radio range and select the one with best symmetric link quality to be their current parent bridge node.

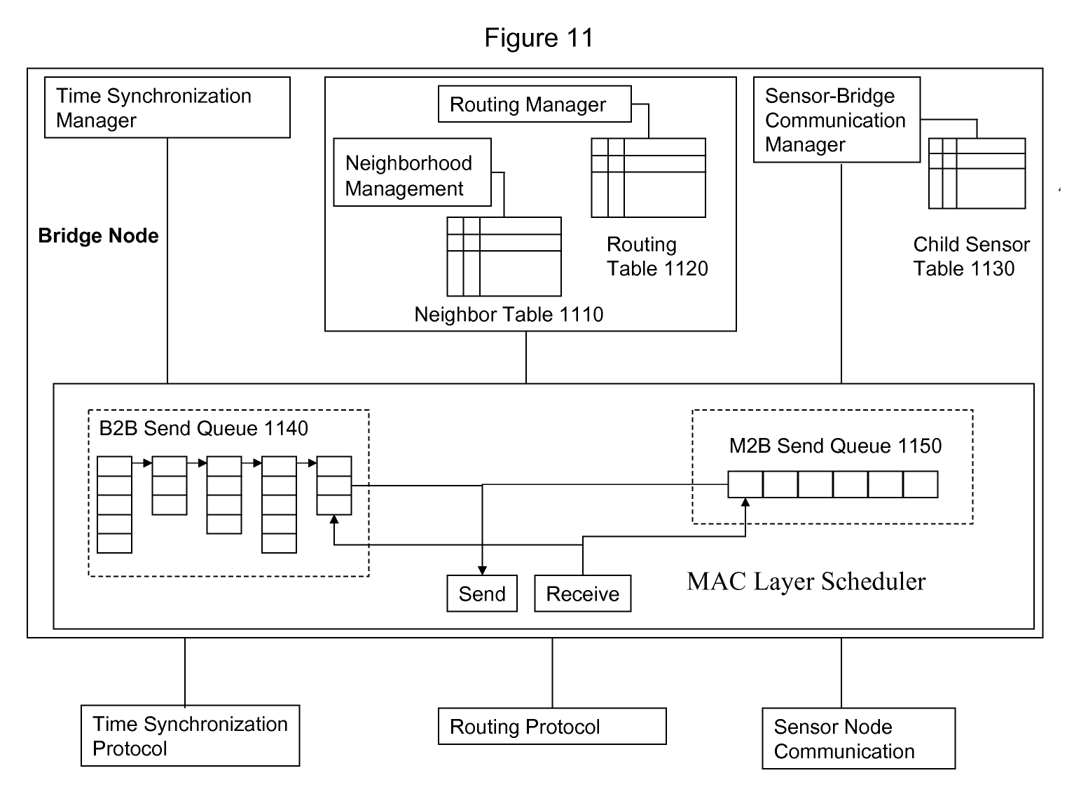

FIG. 11 shows the interaction among the key modules at a bridge node. The key data structures at the bridge node level include: (1) a neighbor table 1110, (2) a routing table 1120, (3) a child sensor node table 1130, (4) a B2B send queue 1140 and (5) M2B send queue 1150. The neighbor table management module maintains a list of active and reliable neighbors. The routing table provides candidates for the next hop for the destination bridge node, display node, or the gateway node. The child sensor node table stores the latest event reported by each child sensor node. The B2B send queue prioritizes data packet transmission to next hop bridge node neighbors, destination display node, or gateway node. The M2B send queue prioritizes data packet transmission to child sensor nodes. In other implementations of the invention, two or more modules may be combined into a single module, or a single module may be divided into multiple modules.

The child sensor node table is updated based on the sensor node to bridge node communication which is handled by the sensor-bridge communication manager. This table stores the latest event reported by each child sensor node. For each new child sensor node based event that needs to be propagated further, the routing manager creates a new data packet, marks it as a packet to be forwarded to the appropriate network node (e.g., gateway node, display node, or bridge node), and adds it to the B2B send queue. The routing manager looks up the routing table for candidates for the next hop bridge node, destination display node, or gateway node to forward the data packet. Additionally, the parent bridge node issues a query to the central server to learn about the set of display nodes that must be updated when a child sensor node detects a change in the occupancy of a parking space.

Network packets received at the bridge node from other bridge nodes, display nodes, or gateway nodes, are processed by the routing manager and may be further forwarded to the next hop bridge node, destination display node, or gateway node. The next hop candidates are retrieved from the routing table. Entries in the routing table are updated based on information from the current neighbor table. Once next hop node is determined, a data packet is created and the packet is buffered at a send queue for future transmission. Routing protocol packets destined for a child sensor node are sent to the sensor-bridge communication manager for further processing. The sensor-bridge communication manager processes the packet and adds it to the M2B send queue for transmission to the appropriate child sensor node.

The send queues prioritize data packet transmission based on packet priority or the order of arrival. Packets for common next hop neighbors are aggregated or transmitted back-to-back when the transmission window is available.

Media Access Control (MAC) Layer Scheduler

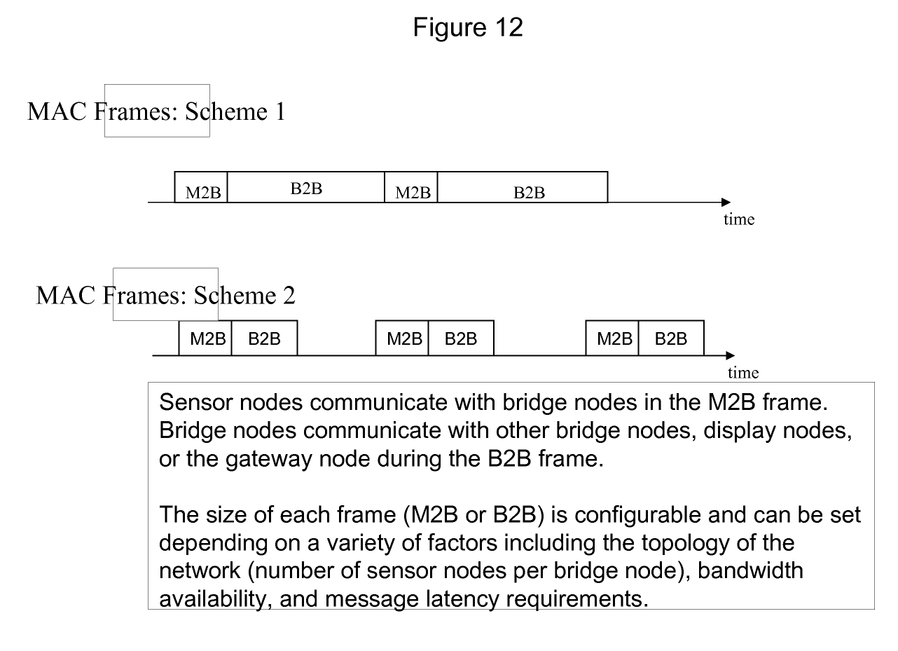

FIG. 12 shows two timing diagrams for different MAC frames. In scheme 1, at the MAC layer, time is divided into recurring time frames. The mote-to-bridge (M2B) frame is dedicated for communication between sensor nodes and bridge nodes. The bridge-to-bridge (B2B) frame is dedicated for multihop data routing between bridge nodes, display nodes, and gateway nodes. The size of each frame (M2B or B2B) is configurable and can be set depending on a variety of factors including the topology of the network (number of sensor nodes per bridge node), bandwidth availability, and message latency requirements.

In one implementation, a MAC layer scheduler at the sensor nodes and bridge nodes implements the MAC layer communication frames shown in scheme 1. In another implementation, the MAC layer scheduler may implement the communication frames in scheme 2. In yet another implementation, the MAC layer scheduler may implement a set of frames different from scheme 1 or scheme 2.

In general, a node may switch off its radio to conserve power if it does not need to communicate (send or receive messages) during a certain time interval. For example, sensor nodes can switch off their radios during B2B frames to conserve power. Additionally, other nodes may also turn off their radios based on the communication frames used in the MAC layer. For example, in the MAC Layer scheme 2 shown in FIG. 12, nodes can turn off their radios during the times when the M2B and B2B frames are not active.

There are advantages of the MAC layer packet transmission scheduling. For example, during the M2B frames, bridge nodes are guaranteed to be in a listen state to receive messages from sensor nodes. Additionally, during the M2B frames, sensor nodes only compete with other sensor nodes in their neighborhood in transmitting data packets to the bridge nodes. They do not have to compete with traffic at the bridge layer. This scheduling facilitates a simple MAC that ensures data packets from neighboring sensor nodes do not collide with communication occurring within the bridge layer during the M2B frame.

MAC Layer for M2B Frame

In one implementation, the slotted ALOHA protocol is used in M2B frames. At the MAC layer, sensor nodes that have detected an event to report compete with sensor nodes in their radio range to send messages to the bridge layer during the M2B frames. The event generation rate depends on the activity in the parking lot or the number of cars entering or exiting the neighborhood of a bridge node listening for sensor nodes in its radio range. If the parking spaces are close to each other, the sensor nodes would be densely deployed but only a small percentage of them may actually have an event to report concurrently in a given M2B frame. Among the competing sensor nodes, the load is further distributed by the multiple bridge nodes in their local neighborhood. Therefore, the total number of packets generated in a given M2B frame for particular bridge node is a small fraction of the sensor nodes within its radio range. In short, the rate of MAC layer collision at the receiver bridge node is inherently low due to low event generation rate and the redundancy of bridge nodes in the sensor nodes' local neighborhood.

A simple MAC solution such as the slotted ALOHA protocol, which relies on randomization to avoid collisions, is effective even in peak traffic conditions. Slotted ALOHA has minimum overheads and is proven to have high throughput efficiency in low traffic conditions. The sensor nodes receive a random slot number for future transmissions from the bridge node in the acknowledgement packet (ack) of a transmission. The slot size is equal to the round trip delay of a packet transmission. The data transmission and the corresponding acknowledgement packet reception is an atomic operation. For a sensor node, if the transmission fails due to failure in receiving acknowledgement packet, the data transmission is scheduled for the same slot in the subsequent M2B frame. Bridge nodes simply listen for incoming event messages from sensor nodes and generate appropriate acknowledgement packet messages.

In other implementations, other network control protocols may be used at the sensor nodes, such as ALOHA, carrier sense multiple access (CSMA), carrier sense multiple access with collision detection (CSMA/CD), carrier sense multiple access with collision avoidance (CSMA/CA), carrier sense multiple access with bitwise arbitration (CSMA/BA), 802.11 RTS/CTS, and others.

MAC Layer for B2B Frame

In one implementation, CSMA/CA is used in the B2B frame. Since the properties of the bridge layer are similar to traditional wireless ad hoc network, the bridge layer MAC uses an adapted CSMA/CA protocol to resolve contention while routing during the B2B frame. CSMA/CA is a cost effective and stable MAC solution for a low data rate network, where the data packets are small. For transferring larger packets, the MAC protocol is a CSMA/CA with request to send/clear to send (RTS/CTS). RTS/CTS is a mechanism by which the sender node broadcasts a request to send message and the receiver node sends a clear to send message to warn their neighbors about an ongoing packet transmission and its duration.

The RTS/CTS mechanism solves the hidden terminal problem, where collisions of data packets occur at the common receiver node because different sender nodes outside of each other's communication range and unaware of the each other's transmission, transmit packets at the same time. The hidden terminal problem can lead to low throughput during large packet transmissions. At the send queue, if there are multiple packets outstanding for a given next hop bridge node, RTS/CTS enabled data transmission disables individual acknowledgement packets to improve packet throughput on a per hop basis. Another optimization is the merging of multiple smaller packets for the same next hop (receiver node) into a single larger data packet to reduce the overall overhead associated with transmitting multiple packets. This optimization is complemented by a module to split large packets into original individual packets for separate processing and routing to their corresponding sinks at the receiver node.

In other implementations, other network control protocols may be used at the bridge nodes, such as ALOHA, carrier sense multiple access (CSMA), carrier sense multiple access with collision detection (CSMA/CD), carrier sense multiple access with collision avoidance (CSMA/CA), carrier sense multiple access with bitwise arbitration (CSMA/BA), 802.11 RTS/CTS, and others.

Time Synchronization

In an implementation with a distributed environment, the clocks of nodes in a neighborhood are synchronized to enable MAC layer scheduling, and to synchronize the sleep/wake schedules of the sensor and bridge. Since hardware clocks are imperfect, local clocks of nodes may drift away from each other in time, hence observed time or durations of time intervals may differ for each node in the network.

Additionally, the clock crystal frequency may be affected by environment factors, such as temperature, pressure, battery voltage, and others. In an implementation, the MAC layer scheduling does not require stringent time synchronization. Loose time synchronization among neighboring nodes is sufficient. The MAC layer adopts distributed time synchronization (e.g., asynchronous diffusion protocol), which is more cost effective than global clock synchronization algorithms. Distributed time synchronization trades off the synchronization precision achieved by algorithms with the associated communication and processing overheads. The system initiates a network-wide, controlled flood at the gateway node that propagates through the entire network to resynchronize the local time at bridge nodes to the system time at the gateway node. Nodes that fail to receive a gateway node initiated time synchronization packet within the expected interval trigger a self-timer based synchronization protocol, and initiate synchronization packet exchanges in their local neighborhood.

Time synchronization messages are proactive control messages that are exchanged periodically. The parent bridge nodes send time synchronization messages to their child sensor nodes as part of the acknowledgement packets for any communication initiated by the sensor nodes. Thus the sensor nodes check their local clock drift by periodically updating their local time to their parent bridge node's system time.

In other implementations, time synchronization may be achieved with Cristian's algorithm (see F. Cristian, “Probabilistic Clock Synchronization,” Distributed Computing 3:146-158, Springer-Verlag 1989), flooding time synchronization protocol (see Miklós Maróti, Branislav Kusy, Gyula Simon, and Ákos Lédeczi, “The Flooding Time Synchronization Protocol,” Proceedings of the 2nd International Conference on Embedded Networked Sensor Systems 2004), reference broadcast synchronization (see J. Elson, L. Girod, and D. Estrin, “Fine-Grained Time Synchronization Using Reference Broadcasts” in Proceedings of the Fifth Symposium on Operating Systems Design and Implementation (OSDI 2002), Boston, Mass., December 2002), Timing-Sync Protocol for Sensor Networks (S. Ganeriwal, Ram Kumar, and M. Srivastava, “Timing Sync Protocol for Sensor Networks,” ACM SenSys, Los Angeles, November 2003), and Internet network time protocol (NTP).

Neighborhood Management

In an implementation, the neighbor table at a bridge node has a list of active bridge nodes in the neighborhood. The neighbor table is dynamic in nature and it is affected by node or link failure. Node failure is rare for bridge nodes but the temporal link quality is variable in low power, short range wireless networks. The link quality varies with time depending on weather conditions, temporary physical obstructions in the environment, antenna orientation, fading characteristics, and physical separation from its bridge nodes neighbors.

The neighbor table stores the one hop bridge node, display node, and gateway node neighbors of a given bridge node, as long as their associated estimated link quality index is greater than a threshold level that indicates stable bidirectional connectivity. The neighbor table also stores parameters such as packet error rate and spatial coordinates of each bridge node. The periodic time synchronization messages could be used to indicate the latest connectivity status among neighbors.

While routing, there are neighbors that do not yield a valid route after several hops due to the current network topology. A parameter known as the route error rate determines the effectiveness of a neighbor in yielding a stable multihop route to the destination node. Neighbors with high route error rates that consistently fail to yield valid routes through themselves are gradually evicted from the neighbor table. The goal of neighborhood management is to estimate the reliability of neighbors at the bridge layer in order to improve the probability of end-to-end packet delivery.

Sensor-Bridge Communication Manager

In an implementation, the sensor-bridge communication manager is responsible for communication between a bridge node and its child sensor node. Radio communication at sensor nodes is switched off during the B2B frame. If a sensor node detects any events during a B2B interval, they are reported to the parent bridge node during the following M2B interval. The sensor-bridge communication manager is active during the M2B interval. Besides event packets, sensor nodes also generate health messages periodically to update the central server, such as the residual battery level, and any sensor malfunction. The frequency of the health messages is very low and they are routed to the gateway node to update the central server. If there are any pending data packets containing health or event data to be sent during the M2B frame, the sensor node implements the slotted ALOHA MAC schedule packet transmission. It then waits for an acknowledgement packet from the bridge node. If none is received, the sensor node times out and retransmits the packet in the subsequent M2B frame.

At the bridge node, packets from the sensor nodes are processed into data packets and are handed over to the routing manager to be forwarded towards the respective display nodes, bridge nodes, or gateway node. The child sensor node table at the bridge node maintains the most recent event update received from the child sensor nodes. Such redundancy of information at parent bridge nodes is important to retransmit the latest events if data is lost while routing.

Network Routing

The bridge layer plays a important role in routing. In one implementation, the data communicated to bridge nodes from the sensor nodes in one-hop and is handled by the sensor-bridge node communication manager and the MAC scheduler as described in a previous section. Bridge nodes also route data from bridge nodes to destination displays nodes and the gateway nodes. In another implementation, bridges may not exist and sensor nodes may form a mesh network among themselves and transmit messages to display nodes and gateway nodes.

In one implementation of the invention, the pseudocode for the routing protocol is as follows:

(i) Every node maintains a cache of next hop information for every destination node to which it has forwarded packets successfully.

(ii) Node A receives a message from node C, to be forwarded to node D.

(iii) Node A checks its cache to see if there is an entry for the corresponding destination node.

(iv) If there is a cache entry for the destination node, the data packet is sent to the next hop, node B, stored in the cache.

(v) If there is no cache entry for the destination node, node A chooses a neighbor, node B, from its neighbor table, which is closest to the destination and has good link quality with respect to node A.

(vi) Node A forwards the message to node B.

(vii) Node B follows the same algorithm and tries to forward the message.

(viii) If node B could not forward the message through all possible routes, it backtracks and sends the data packet back to node A.

(ix) On receiving the backtracked message, node A removes the entry corresponding to node B from its cache for that destination node, if the entry was already present in its cache.

(x) On receiving the backtracked message, the node A tries the next closest node with good link quality and forwards the message to it.

(xi) If node A is unable to forward the message to the destination node after trying neighbors closest to the destination node with good link quality, it tries to send the message to a node with poor link quality that is closer to the destination node.

(xii) After exhausting all neighbors closer to the destination node, node A backtracks and sends the message back to node C.

(xiii) The cache is updated on every successful or failed delivery by changing the next hop information accordingly.

In one implementation, the routing protocols estimate the temporal link quality, packet error rate, route failure rate of neighbors in real time at the neighbor table. So, the protocols could select more reliable neighbors as potential packet forwarders and avoid lossy links. There is a per hop implicit hardware acknowledgement exchanged for each successful data transmission. If the acknowledgement wait timer expires at the sender node and the acknowledgement packet is not received, the data packet is retransmitted. If a next hop fails to yield a valid path at any intermediate bridge node between the source and the destination node, then intermediate node intelligently reroutes the packets through an alternate route. The routing protocols are robust enough to establish alternate routes when primary routes fail due to unpredictable node or link failure. For critical packets such as configuration packets, end-to-end acknowledgement packets could confirm data delivery and ensure that nodes are properly configured in the bootstrap phase.

In one implementation, the routing protocol is designed to be scalable to support thousands of nodes. Instead of running centralized algorithms to compute optimal path in network graph connecting source destination pairs, the protocol uses localized algorithms that use only local neighborhood information to discover routes. Since the network topology varies with time owing to transient link failures and interferences, it is expensive to update the network topology at a central base station on a global scale in real-time. Real-time knowledge of immediate neighbors is used to compute next hop nodes while routing to keep computation and communication overheads of the routing protocol low for better scalability. The routing protocol uses knowledge of bridge node parameters such as their location or spatial coordinates in the field to aid routing. Knowledge of the locations of destination nodes and neighbors helps the routing protocol to make routing related decisions in a localized manner.

The routing protocol avoids routing loops to avoid wasting network bandwidth and resources. Otherwise, the system may lose packets and packet throughput will reduce causing more traffic congestion in the network. The routing protocol may use location-aided routing to completely avoid formation of routing loops. The routing protocol ensures that the packets are consistently routed in the direction of the destination node, such that the next hop is always closer than the current hop to the destination. By adopting this routing logic, a node will never visit a node already visited during its journey towards the destination node, which eliminates the likelihood of loop formation.

The routing protocols in the networking software vary depending on the nature of data collection or reporting applications. The most prominent kind of routing application is any-to-any routing between the bridge nodes, display nodes and gateway nodes. Other routing applications include aggregation trees to collect network health and management data from the bridge and sensor nodes. The time synchronization uses a network wide controlled flooding approach initiated at the gateway node since all nodes participate in this protocol. Occasionally, data dissemination protocols from the root disseminate commands or configuration parameters to the entire network or specific nodes in the network.

In an implementation, the bridge nodes receive event packets from sensor nodes and identify the destination display nodes by looking up the sensor node to display mapping. For each child sensor node, a bridge keeps a list of display nodes that need to be updated when the child sensor node detects a change in parking space occupancy. The bridge node queries the central server to get access to the list of display nodes. At run time, the event data from parent bridge nodes is routed towards the respective display nodes to update their availability counts in real time.

In another implementation, bridge nodes are aware of the locations of the destination display nodes. The neighbor table in the bridge node also has the location of the neighboring nodes. The protocol uses geographic forwarding as a form of location based routing. Geographic routing accommodates the case of 3-dimension node coordinates generated on the basis of the field network deployment. The routing protocol may use geographic forwarding where each node decides its next hop based on selection of a reliable neighbor whose Euclidean distance is closer than itself to the destination node. This routing logic is executed at each intermediate bridge node beginning from the source bridge node until the destination node is one hop away from any intermediate node on the route.

Advantages of geographic forwarding are natural avoidance of routing loop formation and low computation and memory overheads. A local minimum results when an intermediate node is not able to find any neighbor closer to the destination. If a node gets stuck at a local minimum while executing the greedy forwarding function, the packet may retrace its path and attempt geographic forwarding from a previous node in the forward path. This may lead to discovery of an alternate connected route in a direction different from the initial route.

One implementation may use strategies to determine the boundary of the voids in the network, where voids are bounded regions in the network devoid of any connected nodes. Instead of backtracking, the routing protocol may also implement an algorithm that routes the data packet along the boundary of the void to reach the destination in a deterministic manner.

In one implementation the routing algorithm may use a distributed algorithm proposed by Fang et al. (see Qing Fang, Jie Gao, and Leonidas J. Guibas, “Locating and Bypassing Holes in Sensor Networks,” The 23rd Conference of the IEEE Communications Society (INFOCOM), v. 23, n. 1, 2458-68, March 2004), to build routes around holes, which are connected regions of the network with boundaries consisting of all the stuck nodes.

In one implementation, bridges may multicast an update from a child sensor node to the destination display nodes. Multicasting is effective as it reduces overheads associated with unicasting and helps reduce the energy and bandwidth required to send the information to the destination nodes.

In one implementation, the system collects network management data from the entire network and updates the central server periodically. An aggregation tree could span all nodes in the network with the root of the tree as the gateway node. Instead of using any-to-any routing between each node and the gateway node that connects to the root node, an aggregation tree could eliminate or reduce congestion near the gateway node created by several independent packet flows. There are several ways to construct aggregation trees, such as spanning trees, depth first or breadth first trees. All nodes could keep track of number of hops they are away from the gateway node through the periodic messages. This enables bridge nodes that are farthest from the root node, or leaf bridge nodes, to select one bridge node from their neighboring bridge nodes which are fewer hops away from the root. Bridge nodes may select the next hop bridge node with the best link quality over time to increase reliability or stability of the aggregation tree. The aggregation tree is thus built in a bottom up manner and dynamically adapts to random link failures in the network.

In one implementation, the routing protocol may broadcast information or a command initiated by a node to a certain set of nodes in the network. For example, the packets related to time synchronization could span across the entire network periodically. Similarly, control commands such as initialization or updating of configuration parameters, sensing frequency or shutting down of parking lot may need to be communicated to a set of nodes in the network. The system may use a simple controlled flooding scheme to propagate time synchronization messages in the entire network. Propagation of special commands and control packets issued by the administrator at the central server may be accomplished by either piggybacking the control packet on time synchronization messages or initiating another controlled flood in the entire network.

Queue Management

In one implementation, “send queues” at the bridge node buffer outstanding packets from different elements such as the time synchronization manager, routing manager, and sensor-bridge communication manager. The send queue interfaces with the MAC layer to schedule physical transmission of packets and buffers them until it receives an acknowledgement packet from the next hop. If the send queue fails to receive an acknowledgement packet from a packet transmission, it times out and re-transmits the packet. There are two send queues at the bridge node, one to handle bridge layer traffic during B2B MAC frame, called the B2B send queue, and another for communication with the sensor nodes during M2B frame, called M2B send queue.

In one implementation, during heavy network traffic conditions the rate of packet transmission could be slower than the rate of packet generation due to MAC delays. Therefore packets are buffered while the node contends for a MAC channel. Send queues not only buffer data, they also handle packet transmission based on priority and facilitate the MAC layer protocol and optimizations. Different packets could be assigned different priorities. For example, configuration parameters sent by the root to all nodes and event data generated by source bridge nodes for display nodes could be the most critical data packets, whereas network health and time synchronization messages have lower priority. Once the physical channel is clear for packet transmission, the packets with highest priority are transmitted first. Therefore, the send queue buffers packet in the descending order of their priority. Packet priority could depend on a variety of factors including packet type, number of outstanding messages for the same next hop, and time elapsed since packet was enqueued.

Data Management

In one implementation, as shown in FIG. 11, there are various data structures or tables that store information at nodes. There are tables related to configuration parameters at run time, the neighbor table is formed and updated using periodic messages. The child sensor node table stores the latest events from sensor nodes. The routing table stores potential next hop candidates for various destination display and gateway nodes. The display nodes store latest events from member sensor nodes. This distributed information is constantly overwritten by real-time data exchanged among the nodes which include sensor nodes, bridge nodes, gateway nodes, and destination display nodes.

All data structures related to neighborhood management, routing, sensor node to bridge communication, queue handling share the finite storage space available at a node. In one implementation, smart insertion and eviction schemes are used for optimal use of the node memory. Unwanted or stale entries are promptly evicted from data storage tables and only the most relevant entries remain. A good example of data management at bridge node level is neighborhood management. Besides data management for data structures used in various nodes, provisions exist for limited caching or logging. The source bridge nodes log the latest events to enhance reliability of message routing by initiating a retransmission of event data from the source bridge node to its destination display or gateway node if the original message is not delivered successfully. Limited logging or caching at the bridge node stores some of the recent packet routes observed by the bridge node. Such route caching is useful for a fall-back mechanism for alternate path routing, when packets need to retrace their paths. The node's permanent storage has a log of the configuration parameters so that they are never destroyed in case of temporary node failure. The node on revival can rely on the logged configuration parameters to reconnect to the wireless network.

Aggregation

In one implementation, the system uses in-network aggregation and processing of data to reduce communication overheads at the cost of increased computation overheads for large scale monitoring of parking spaces through wireless networks. Data aggregation may be performed in a spatial or temporal manner. Bridge nodes may collect and combine events generated from multiple sensor nodes for the same destination, or multiple events generated by the same sensor node for the same destination over a period of time. If the data reported to a sink is an accumulation of sensor readings generated by nodes belonging to a particular region of the network, it is more optimal to combine them close to the source of the information as possible, than to aggregate them at the sink. Therefore, local aggregation schemes to aggregate and combine sensor node data meant for the same sink reduces the total volume of sensor data sent out of the network. In-network processing trades processing overhead with communication overhead to save the overall consumption of network resources. Similarly, health diagnostic data collected from the entire network is transmitted through suitable aggregation trees to save network routing overhead and promote data piggybacking or combining at the MAC level to reduce channel contention at the link layer.

Network Configuration

In one implementation the wireless parking guidance system operates unattended for its entire lifetime. Therefore, it is important to configure the nodes properly so that they can resume normal operations once nodes restart after temporary failures. The central server provides the configuration parameters that are used to set the node and to support its run time behavior. These are parameters that describe the specific node's properties such as its location, MAC window frames, sensing frequency and threshold sensor values, etc. The configuration parameters are usually stored in permanent storage area so that in case of node failure the node can restart enter the bootstrap phase, and reconnect to the network.

In one implementation, the system may support network programming to dynamically transmit program code from the central server to a bridge node. The central server transmits the new program code to the gateway which then wirelessly transmits the code to a bridge node. This program code is then loaded into the bridge node and the bridge node executes the new code. Network programming saves the efforts of uninstalling and reprogramming each bridge node manually.

Design of Parking Guidance Information Dissemination

In one implementation, the primary guidance information dissemination device is the display node installed at the intersections in parking lots to guide visitors to available parking spaces by messages flashed onto the display screens. In another implementation, the system could provide parking information and guidance to visitors through their cell phones, PDAs, via browsers, or vehicle dashboards, or other devices.

In one implementation, light emitting diodes (LEDs) may be installed on the ceiling or walls above each parking space. These LEDs may be turned on or off depending on the occupancy status of the space. Visitors to a parking facility may look up to quickly identify the specific parking space that is available. In another implementation, a red and a green LED may be mounted on top of each parking space. If the space is occupied, the red LED is active and the green LED is inactive. When the space becomes vacant, the green LED becomes active and the red LED turns inactive. The LEDs include a wireless adapter to obtain data packets from the network and display the space status accordingly.

In another implementation, traffic control inspectors or personnel may use the guidance information to control traffic flow to avoid congestion in parking facilities. They may obtain browser based views of occupancy information of the entire parking lot to direct the traffic towards underutilized parking zones. This is in addition to automated guidance provided by displays during peak traffic conditions on holidays or special events. Moreover, parking facilities management staff can obtain a macroscopic view of the parking activity in the entire parking facilities remotely at a monitoring console located in an office.

In one implementation, commuters may query a web-based interface to search for available parking spaces in a particular locality or parking facility. The parking space occupancy information is processed to identify the available spaces and users are then made aware of these spaces.

Hardware Design of Display Nodes

Display nodes are electronic display devices that show message signs and include a wireless adapter to obtain data packets from the network. In an embodiment, the display device could be an off the shelf or custom LED display that fits the customer requirements. The LED displays may of different types. They could be for indoor or outdoor use. They may be dot matrix, segmented displays, or other types. The displays may have a different number of digits or display different languages. The type, size, and color of each character and sign may be different for displays located in different parts of the parking facility. The display nodes may be connected to a power outlet and installed at the entrance of parking lots and aisles such that they are easily visible to the incoming traffic. The displays may also be battery powered, solar powered, or powered by some alternative energy source.

Software Design of Display Nodes

In one implementation, software design of display nodes includes one primary software module. A data processing module combines event data from the network into appropriate guidance information. The display node maintains a list of source sensor nodes and updates their status as it receives new events. The data processing module computes the results and provides the information to the display controller to flash onto the display screen in the form of appropriate messages and symbols. The execution environment at display nodes is embedded Linux. To provide enhanced guidance information to visitors, the display performs intelligent transformation of information it receives from the network. In other implementations, the display node may contain more than one software module. The execution environment at the display nodes may be an environment other than embedded Linux, such as TinyOS, Linux, real-time operating systems (RTOSes), Mobilinux, and others.

Transformation

In one implementation, displays present cumulative counts of the aisle or a given parking zone by obtaining data events from source sensor nodes. The displays may intelligently transform the available parking space count when it reaches a threshold level to provide a more meaningful interpretation of the information presented to visitors. For example, if the available spaces are very few and the lot is close to fully occupied, the displays may present a text message indicating the lot is almost full. This message serves as a warning to incoming commuters about low probability of finding a vacant spot in the given lot or aisle. Thus, transformation of a numeric count to a warning or special message enhances the effectiveness of the overall application by providing more user-friendly communication to commuters.

Administration and Management Tools

As described in a previous section, administration and management tools are important to make sure the key system components, such as parking space monitoring, communication layer, and guidance information dissemination, work properly throughout the lifetime of the system. Since the parking management system is an unattended and automated system, remote administration and management tools are necessary to obtain feedback from the system related to its performance and to discover maintenance tasks as soon as they arise.

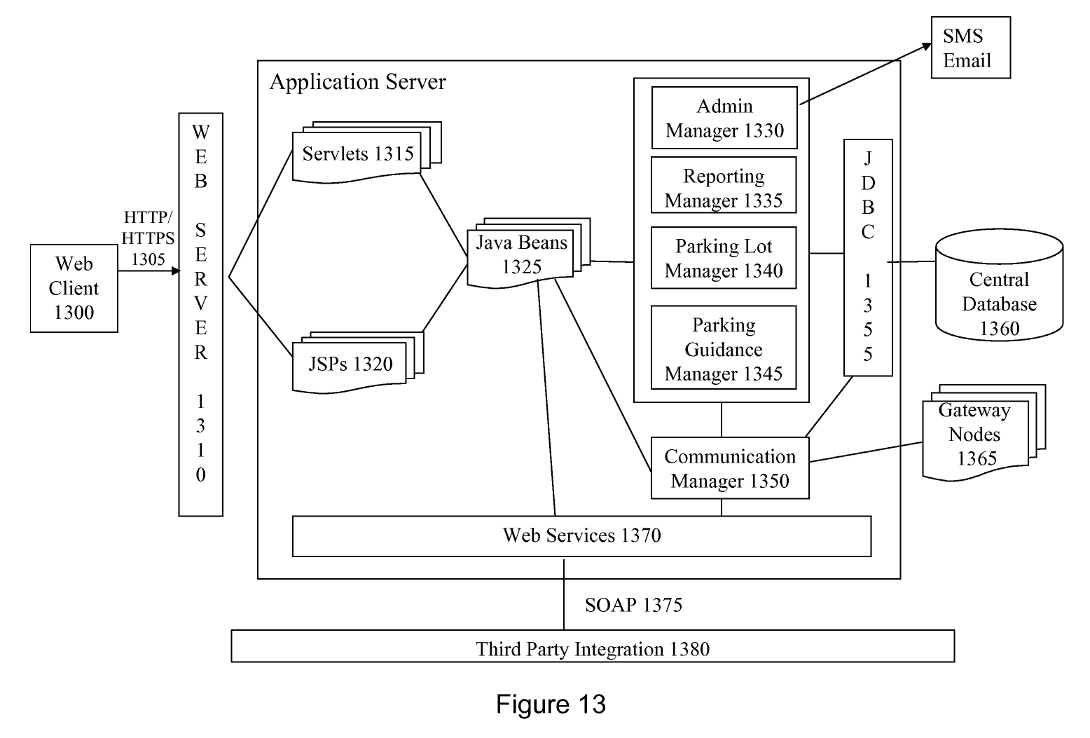

FIG. 13 shows the design of the central server. In one implementation, browser based clients 1300 access the server 1310 either via a hypertext transfer protocol (HTTP/HTTPS) interface 1305 and third party integration clients 1375 access it via a simple object access protocol (SOAP) interface 1380. In the case of browser based clients, individual web pages are implemented as front-end Java servlets 1315 or Java server pages (JSPs) 1320 and the session state is maintained within Java Beans 1325. Additionally, the central server contains back-end elements called managers (1330-1350) that process data and respond to client requests. The managers communicate with the central database 1360 via the Java database connectivity layer 1355.

In one implementation, based on the client's request, a Java Bean interacts with an appropriate manager to cater to the request. Admin manager 1330 is responsible for system administration and network maintenance tasks such as sending administrative alerts, displaying the health of individual nodes, displaying the health of the network, and other tasks. Reporting manager 1335 displays real-time views of the parking lots as well as provides reports on historical data. Parking lot manager 1340 manages parking lot activities, such as when the parking facility is open or close. Parking guidance manager 1345 sets the messages to be shown on the displays, associates displays with parking spaces, and other tasks. Communication manager 1350 manages the communication between the server and gateway nodes 1365.

In one implementation, the central server may also support a web-services-based application programming interface (API) 1370 to facilitate integration with third party systems. The third party systems include revenue management systems, reservation systems, enterprise portals, parking garage management systems, and other systems. These systems send and receive messages using the SOAP and typically interact with the server in an automated manner (i.e., no human involvement).

Network management is an important service carried out on the wireless network to obtain parameters related to individual node health and proper functioning of the sensor nodes, bridge nodes, and displays. Alerting is a management tool to inform the administration staff about maintenance tasks or an impending failure of nodes or links. The administrators also perform the important duties of initializing and updating control parameters to monitor parking activities. Administrators have the flexibility to control the sensing interval, or discontinue monitoring in a particular parking lot if they need to temporarily reserve it for another activity and then resume normal parking monitoring in that lot later. They may customize messages sent over displays to notify visitors or navigate them in a certain direction to control traffic. Administrators have the flexibility to control parking operations by issuing commands to the wireless network that could reset the default software parameters at nodes to new values, for example, to modify the sensing frequency of sensor nodes.

Since network management data and administrative privileges are sensitive, security features have been designed to protect this information from intruders, and to ensure that only authorized personnel can access management data monitoring or administrative privileges.

Network Management

In one implementation, the network management service continuously monitors the network health, and facilitates administrators to take corrective operations to ensure that the network operations are not disrupted by frequent link failures or occasional node failures. Sensor and bridge nodes periodically send data related to the status of their various components such as battery, sensors or radio links to the central server.

In one implementation, a history of network health parameters is maintained at the central repository to enable network maintenance and debugging tasks such as identifying and replacing nodes that have battery power less than a threshold level. Some nodes may show poor network connectivity due to physical obstacles and signal fading which could be handled by changing the orientation or physical position of node or adding redundancy to the network. At other times, the sensor at the sensor node may be malfunctioning or poorly calibrated. A connectivity and node battery level graph is maintained at the central server which is continuously updated to obtain the latest view of network topology. Feedback on the average routing load at each bridge node during B2B frames could identify hot-spot or areas in the network topology experience network congestion.

Alerting

In any large scale distributed system, alerts are an indispensable tool to notify the system administrators for anomalous situations such as malfunctioning nodes. Each node carries out self-diagnosis and reports to a central manager with information about their battery health or network connectivity condition. Nodes periodically send a probe to keep track of their neighbors' health or link quality. So, neighbors of the nodes not functioning properly may generate alerts for the system administrator based on their probe response. Other types of software alerts could be application specific. For example, if a vehicle such as a motorcycle is parked in a parking space meant for cars, suitable alerts may be raised by the sensors to notify the parking facility to take action during such situations. Additionally, if the sensor node continues to make anomalous readings that neither confirm the presence or the absence of a vehicle (for e.g., a vehicle may be incorrectly parked across two parking spaces) an alert is raised to notify the system administrator.

Security

In an implementation, it is important to secure data that is transmitted over the wireless network since the network is susceptible to snooping. The system uses encryption schemes to protect data from intruders. It is also important to verify that the packets are received from a valid network node and not from a malicious one. The system uses authentication and encryption mechanisms to protect the network from such security attacks. Additionally access privileges are assigned to authorize parking personnel who use the administrative or monitoring console to protect data from intruders.

Reporting

Users can view the monitoring console to view the parking lots in real-time as well as obtain elaborate reports on historical parking activity as well perform deep analysis to gain insights into parking operations. In one implementation, users are provided with novel real-time views of the parking areas that allow the user to zoom in and out of parking facilities while being able to view the occupancy status of each parking space. Spaces are depicted in different colors based on their occupancy status.

The central database records fine-grained historical information related to parking operations including data relating to parking occupancy, policy violation, enforcement personnel activity, etc. The system processes this information and generates elaborate reports containing a variety of parking related metrics including parking space utilization, average duration of stay, number of vehicles being parked, etc. For example, managers can view the daily-to-annual space utilization and parking duration related statistics for their lots, leverage parking information to count the number of people visiting their facility, detect unauthorized movement, possible abandoned vehicles, and extrapolate the information to make appropriate operational and financial decisions. Access privileges are assigned to authorize personnel for accessing these views on the monitoring consoles.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. A system comprising:
a first plurality of sensor nodes distributed in a first parking area to detect the presence of vehicles in parking spaces the first parking area, wherein the sensors transmits detection information wirelessly;
a first bridge node in the first parking area, wirelessly coupled to the first plurality of sensors;
a first plurality of display nodes in the first parking area, wirelessly coupled to the first bridge node, wherein each display node provides an indication of where open parking spaces are located in the first parking area; and
a first gateway node, wirelessly coupled to the first bridge node and an administrative console to control operation of the system.

2. The system of claim 1 further comprising:
a second plurality of sensor nodes distributed in a second parking area to detect the presence of vehicles in parking spaces the second parking area, wherein the sensor transmits detection information wirelessly;
a second bridge node in the second parking area, wirelessly coupled to the plurality of sensors;
a plurality of display nodes in the second parking area, wirelessly coupled to the second bridge node, wherein each display node provides an indication of where open parking spaces are located in the second parking area; and
a second gateway node, wirelessly coupled to the first bridge node and to the administrative console.

3. The system of claim 2 wherein the first parking area is a first level of a parking structure and the second parking area is a second level of a parking structure.

4. The system of claim 1 wherein there is one sensor node for each parking space in the first parking area.

5. The system of claim 1 wherein there is one sensor for a plurality of parking spaces in the first parking area.

6. The system of claim 1 wherein the parking spaces in the first parking area are arranged in aisles, and the there is a sensor node at an exit of each aisle.

7. A method comprising:
using a first sensor node, detecting whether a vehicle is present in a first parking space of first parking area;
from the first sensor node, wirelessly transmitting information on whether the first parking space is occupied to a bridge node; and
updating a display to reflect whether the first parking space is occupied or unoccupied based on the information received by the bridge node.

8. The method of claim 7 further comprising:
using the first sensor node, detecting whether a vehicle is present in a second parking space of first parking area;
from the first sensor node, wirelessly transmitting information on whether the second parking space is occupied to the bridge node; and
updating the display to reflect whether the second parking space is occupied or unoccupied based on the information received by the bridge node.

9. The method of claim 7 further comprising:
using a second sensor node, detecting whether a vehicle is present in a second parking space of first parking area;
from the second sensor node, wirelessly transmitting information on whether the second parking space is occupied to the bridge node; and
updating the display to reflect whether the second parking space is occupied or unoccupied based on the information received by the bridge node.

10. The method of claim 7 further comprising:
when the first parking space becomes occupied, reducing a count of unoccupied spaces in the display.

11. The method of claim 7 further comprising:
when the first parking space becomes unoccupied, increasing a count of unoccupied spaces in the display.

12. The method of claim 7 further comprising:
after the first parking space becomes occupied and the second parking space is unoccupied, providing an indicator at the display to direct for a driver to drive toward the second parking space.

13. The method of claim 12 further comprising:
after the first parking space becomes unoccupied and the second parking space remains unoccupied, providing an indicator at the display to direct for a driver to drive toward either the first or second parking space, depending on whether the first or second parking space is located closer to the display.

14. The system of claim 1 wherein the first plurality of sensor nodes comprises sensors capable of detecting changes in magnetic field.

15. The system of claim 1 wherein there is one sensor node for each parking space in the first parking area.

16. The system of claim 1 wherein there is one sensor for a plurality of parking spaces in the first parking area.

17. The system of claim 1 wherein the parking spaces in the first parking area are arranged in aisles, and the there is a sensor node at an exit of each aisle.

18. The system of claim 1 wherein two or more sensors associated with a parking space in the first parking area exchange information in order to determine the presence of a vehicle parked in the parking space.

19. The system of claim 1 wherein the plurality of sensor nodes comprises a sensor node having a replaceable battery, wherein the sensor node and replaceable battery are enclosed in a weatherproof enclosure.

20. The system of claim 19 wherein the weatherproof enclosure protects the sensor node and replaceable battery from at least one of sunlight, rain, wind, sand, dust, or dirt without losing functionality at the sensor node.

21. The system of claim 1 wherein a sensor node of the first plurality of sensor nodes comprises an algorithm accounting for drift in readings and magnetic interference.

22. A method comprising:
using a first sensor node, detecting whether a vehicle is present in a first parking space of a first parking area;
from the first sensor node, wirelessly transmitting information on whether the first parking space is occupied to a bridge node; and
updating a display to reflect whether the first parking space is occupied or unoccupied based on the information received by the bridge node.

23. The method of claim 22 further comprising:
using the first sensor node, detecting whether a vehicle is present in a second parking space of the first parking area;
from the first sensor node, wirelessly transmitting information on whether the second parking space is occupied to the bridge node; and
updating the display to reflect whether the second parking space is occupied or unoccupied based on the information received by the bridge node.

24. The method of claim 22 further comprising:
using a second sensor node, detecting whether a vehicle is present in a second parking space of first parking area;
from the second sensor node, wirelessly transmitting information on whether the second parking space is occupied to the bridge node; and
updating the display to reflect whether the second parking space is occupied or unoccupied based on the information received by the bridge node.

25. The method of claim 22 further comprising:
when the first parking space becomes occupied, reducing a count of unoccupied spaces in the display.

26. The method of claim 22 further comprising:
when the first parking space becomes unoccupied, increasing a count of unoccupied spaces in the display.

27. The method of claim 22 further comprising:
after the first parking space becomes occupied and the second parking space is unoccupied, providing an indicator at the display to direct a driver to drive toward the second parking space.

28. The method of claim 27 further comprising:
after the first parking space becomes unoccupied and the second parking space remains unoccupied, providing an indicator at the display to direct a driver to drive toward either the first or second parking space, depending on whether the first or second parking space is located closer to the display.

29. A system comprising:
a first plurality of sensor nodes, distributed in a first parking area to detect the presence of vehicles in parking spaces in the first parking area, forming a mesh network wherein each sensor node transmits detection information wirelessly to at least one other sensor node;
a first plurality of display nodes, in the first parking area, wirelessly coupled to the mesh network of sensor nodes, wherein each display node provides an indication of where open parking spaces are located in the first parking area; and
a first gateway node, wirelessly coupled to the mesh network of sensor nodes.

30. The system of claim 29 further comprising:
a second plurality of sensor nodes distributed in a second parking area to detect the presence of vehicles in parking spaces in the second parking area, forming a mesh network wherein each sensor transmits detection information wirelessly to at least one other sensor node;
a second plurality of display nodes, in the second parking area, wirelessly coupled to the mesh network of sensor nodes, wherein each display node provides an indication of where open parking spaces are located in the first parking area; and
a second gateway node, wirelessly coupled to the mesh network of sensor nodes.
